(19) United States
(12) Patent Application Publication
(10) Pub. No.: US 2020/0410552 A1
(43) Pub. Date: Dec. 31, 2020

(54) ADVERTISEMENT CREATION AND PUBLISHING SYSTEM, PROCESS, AND METHOD OF USE

(71) Applicant: Timothy K. Stohlman, Dallas, TX (US)

(72) Inventor: Timothy K. Stohlman, Dallas, TX (US)

(21) Appl. No.: 16/907,137

(22) Filed: Jun. 19, 2020

Related U.S. Application Data
(60) Provisional application No. 62/868,939, filed on Jun. 30, 2019.

(51) Int. Cl. G06Q 30/02; G06N 5/02

(52) U.S. Cl. CPC G06Q 30/0276; G06N 5/025; G06Q 30/0277

(57) ABSTRACT

An advertisement creation and distribution system, process of generating advertisements, and methods of use are presented. The advertisement creation and distribution system, process, and method of use can work with a variety of dynamic templates to produce a variety of textual and visual differences across the advertisements and/or advertisement campaigns. The advertisement creation and distribution system, process, and method of use can create many different advertisements and/or advertisement campaigns for the same products, each with different text and imagery. The advertisement creation and distribution system, process, and method of use can diversify the advertising which is seen by a consumer. The advertisement creation and distribution system, process, and method of use can create new templates (configurations for arranging the text and visual content) easily and add these templates to the system itself.

### CROSS-REFERENCE TO RELATED APPLICATIONS

[1] The present application claims priority to U.S. Provisional Patent Application No. 62/868,939 which was tiled on Jun. 30, 2019, which is hereby incorporated by reference herein in its entirety, including any figures, tables, or drawings.

### FIELD OF THE DISCLOSURE

[2] This disclosure relates to an advertisement creation and publishing system, process and method of use. More specifically and without limitation, this disclosure relates to an advertisement creation system for creating customized advertisement graphics for any of the products for sale on an e-commerce platform.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright AutoScale. All rights reserved.

### BACKGROUND OF THE DISCLOSURE

Advertising is marketing communication that employs an openly sponsored, non-personal message to promote or sell a product, service or idea. Sponsors of advertising are typically businesses wishing to promote their products or services. Advertising is differentiated from public relations in that an advertiser pays for and has control over the message. Advertising is communicated through various mass media, including traditional media such as newspapers, magazines, television, radio, outdoor advertising or direct mail; and new media such as search results, blogs, social media, websites, and even text messages, or mobile alerts. The actual presentation of the message is referred to as an advertisement, or “ad”.

New media, or digital advertising offers many benefits; many of these benefits overcome the deficient and decreasing popularity of traditional advertising. For this reason, digital advertising is quickly becoming the advertising choice for many small businesses, especially those businesses with limited marketing budgets. Digital advertising is prominent in places like social media and search engines, so businesses can get started with advertising campaigns for as little as a few hundred dollars.

For this reason, ads located on social media posts, search engines, YouTube® and elsewhere are preferable. A sponsor (or “user”) can even set up their advertisements in ways that they only pay the host (or advertiser) for clicks actually received. In this way and more, reaching folks through digital advertising methods is often more affordable and preferable.

Another advantage of digital advertising over traditional advertising is that success can be tracked. When a sponsor runs an ad campaign on a digital platform, the sponsor can see how well they are doing in real time. These powerful advertising analytic tools help sponsors and/or businesses determine how to best spend their marketing budgets, and also how to best utilize their marketing budgets. However, even with the analytics tools of today, it is very hard for a regular business owner and/or sponsor to understand how this technology works. Let alone find the time to manage this sophisticated analytical technology.

The development of digital advertisement designs, publications, and customized consumer advertisements and/or advertisement campaigns is often a challenging, complicated, laborious process. The process often involved many authors, editors, proofers, illustrators, artists, and other contributors. The laborious task of developing a single advertisement may include assembling a rough draft from the content of one or more contributors creations, managing, edits made by editors, and relying on various proofers to review the works. Finally, the publication process takes time, attention, and labor. Furthermore, monitoring the success of an advertisement on social media, or another digital platform is tricky. Some analytics exist but accessing, interpreting and understanding these analytics often means hiring a digital marketing specialist.

For these reasons, sponsors face numerous challenges in advertising and promoting their products. Especially when these tasks fall across geographic regions which may be globally. An editor in India may be working with an author in South America, while the author in South America is working with a publisher in the United States. In this way, authors, editors, proofers, illustrators, artists, marketing specialists, influencers, promoters, and other contributors are faced with having to assimilate the contributions from each of these dispersed contributors. In some cases, different users may use different document format, which adds to the complications. In other cases, a contributor and/or user may not be familiar with the interface of the graphic design creator or may otherwise not be familiar with the inner workings of a program, leading to content creation problems.

Thus, business owners, sponsors, and others wishing to market their products face the challenge of creating each piece of content through this laborious process. This process is a manual process. As one of many examples, inserted here strictly to illustrate the difficulty in content generation, we take the example of creating a single advertisement to promote a single product. In the event a user desires to create this single advertisement, the process is tedious and requires a lot of attention of the user.

One amongst many problems a sponsor may face, different contributors to the creation of the advertisement may use different formats (e.g., contributors may use a word processing format such as Microsoft Word® while a proofer may use Adobe's Portable Document Format or PDF (.pdf).) Therefore, publishers and other contributors to the advertisement creation are faced with the challenge of converting various formats and propagating changes in one format to all the different formats used by various contributors.

Advertisement creation is a manual task which requires close attention so that errors aren't made. For this reason, teams of people are often employed to create a single advertisement or advertisement campaign. Each different brand will face challenges of incorporating a business brand into an advertisement campaign. Thus, this is a laborious and tedious task. Publishers and/or other users also struggle to properly track and manage the various versions and revisions of the advertisements they are working on. This becomes tricky and upsets communication and disrupts tracking problems in the content, and furthermore disrupts tracking resolution of any problems that arise during the process. Publishers and other users also rely almost entirely on manual proofing, which itself is a laborious process. These challenges and others are only exacerbated when the content is in the form of electronic content generation, such as new media types including, animation, videos, and the like which would display the media to potential clients, purchasers, or licenses. All of which are very common, and nearly required forms of advertisement material, in today's digital media marketing scheme. This new type of content generation does not easily fit into the existing process or work with existing publishing tools. Below is an example which illustrates some of the difficulties.

Even in new advertising approaches, which use data-driven advertising approaches which use large quantities of data, challenges abound. Interpreting and understanding large quantities of advertising data is difficult. Even the most experienced and seasoned digital advertising specialist have trouble interpreting large quantities of data to make precise and accurate decisions with advertisements or advertising campaigns.

For this reason, bulk online display advertising has become a popular choice for businesses and sponsors. Online bulk display advertising displays ads in levels number the thousands or even hundreds of thousands or millions. In these graphic advertisement displays, an image showing/promoting, a product is shown online which also acts as a link to a product. These bulk online advertising methods can generate awareness quickly.

Unliking searching, which requires someone to be aware of a need, display advertising can drive awareness of something new and/or something a purchaser may desire by other indications such as prior searches or other information gathered. This bulk awareness of something new, of a user's products and without previous knowledge can be critical in successfully marketing a product.

Because the advertisement also can act as a link, display advertising works well for direct responses as well. This makes accessing the products and purchasing the products even easier for a consumer. Display advertising is not only used to generate awareness but is used for these kind of direct response campaigns which generate traffic on a sponsor's website which also leads to better search engine results and other cascades of promotion for a sponsor.

Digital advertising has huge benefits for a sponsor. However, the mountain of problems and the number of people involved can quickly harm a sponsor's prospect of digital advertising, delay the process, or end it altogether. The problems, number of people required, costs of production, and intensity of labor only increase as a second advertisement design is created, a third advertisement design, a fourth advertisement design, and more are added to the task list. When thousands of product advertisements are shown, diversity in the advertisement also becomes an important factor. However, with diversity in the advertisements comes increased cost in having a marketer and/or team of people create such campaigns.

Additionally, many different platforms, sizes, and other marketing challenges face sponsors. An advertisement created for Facebook® may not be sized or work correctly with an advertisement created for another social media platform. Additionally, an advertisement created for a specific target audience in Facebook® may, not work for another target audience within the social media platform. Thus, the challenges of various platforms and e-commerce routes also hinder sponsors wishing to succeed in digital advertising.

Thus, it is a primary object of this disclosure to provide an advertisement creation and distribution system, process, and method of use that integrates with E-Commerce platforms to provide solutions to these issues and more, that allows sponsors to design, create, and launch advertisements and/or advertisement campaigns for products on the E-Commerce platform with a single mouse click.

### SUMMARY OF THE DISCLOSURE

An advertisement creation and distribution system, process, and method of use that integrates with E-Commerce platforms to provide solutions to these issues and more, that allows sponsors to design, create, and launch advertisements and/or advertisement campaigns for products on the E-Commerce platform with a single mouse click.

The advertisement creation and distribution system, process, and method of use can utilize an application programming interface (“API”) to connect to a suitable E-Commerce platform (“Platform”), and provide sponsors with the ability to create customized advertisement graphics (“Ads”) for any of the products for sale on the Platform (“Products”). Furthermore, the disclosure herein provides a sponsor with the ability to post these ads or advertisement campaigns on several different online advertising platforms, which helps to direct traffic to the products. Additionally, the disclosure herein also present a way to create connections to link platforms with the application programming interface. The disclosure herein, provides a means for achieving the entire advertising process of designing, creating, and launching ads and/or advertisement campaigns with only a single click; once information has been accorded.

Furthermore, once the ads and/or advertisement campaigns have launched, the disclosure herein can monitor the performance of the ads and/or advertisement campaigns. In addition to monitoring performance, the disclosure herein can optimize the bids and budgets of the ads and/or advertisement campaigns. Furthermore, the disclosure herein presents a proprietary machine learning technology which can assist the ads and/or advertisement campaigns in sustaining success.

The advertisement creation and distribution system, process, and method of use works across multiple advertising platforms, such as but not limited to, Facebook.com and Amazon.com. The advertisement creation and distribution system, process, and method of use can automatically create advertisements and/or advertisement campaigns from the products hosted on the various platforms.

The advertisement creation and distribution system, process, and method of use can work with a variety of dynamic templates to produce a variety of textual and visual differences across the advertisements and/or advertisement campaigns in this way, the advertisement creation and distribution system, process, and method of use can create many different advertisements and/or advertisement campaigns for the same products, each with different text and imagery. In this way, the advertisement creation and distribution system, process, and method of use can diversify the advertising which is seen by a consumer. The advertisement creation and distribution system, process, and method of use can create new templates (configurations for arranging the text and visual content) easily and add these templates to the system itself.

The advertisement creation and distribution system, process, and method of use utilizes machine learning technology in a way which selects the audiences to which the advertisements and/or advertising campaigns are targeted. Additionally, the system utilizes machine learning technology which configures the bids and budgets of the advertisements and/or advertisement campaigns after launch. Once launched, the advertisement creation and distribution system process, and method of use continues to monitor the performance of the advertisements and/or advertisement campaigns. Once launched, the advertisement creation and distribution system optimizes bids and budgets for maximum performance, while curtailing excessive spending on low-performing advertisements and/or advertisement campaigns. In this way and others, the disclosure herein presents a way to truly incorporate machine learning technology into advertising.

Additionally, the advertisement creation and distribution system, process, and method of use can do all of this by only a single click of a user (selection of a product) to design, create, and launch advertisements and/or advertisement campaigns. In this way, the disclosure herein resolves a complicated, unintuitive, tedious, and repetitive process of designing, creating and launching advertisements and/or advertisement campaigns for a single product and/or multiple products. The advertisement creation and distribution system, process, and method of use can provide all of the benefits in a single disclosure which can complete the goals of a user by a single click, once appropriate information is stored.

Thus, it is a primary object of the disclosure to provide an advertisement creation and publishing system, process and method of use that integrates with e-commerce platforms to provide a solution that allows users to design, create, and launch advertisements and/or advertisement campaigns for products on the e-commerce platform with a single mouse click.

Another object of the disclosure is to provide an advertisement creation and publishing system, process and method of use that integrates with e-commerce platforms.

Yet another object of the disclosure is to provide an advertisement creation and publishing system, process and method of use that can utilize an application programming interface.

Another object of the disclosure is to provide an advertisement creation and publishing system, process and method of use that provides customized advertisement graphics.

Yet another object of the disclosure is to provide an advertisement creation and publishing system, process and method of use that provides a user with the ability to post advertisements.

Another object of the disclosure is to provide an advertisement creation and publishing system, process and method of use that provides a user with the ability to post advertisements on different advertising platforms.

Yet another object of the disclosure is to provide an advertisement creation and publishing system, process and method of use that provides a user with enhanced ability to direct traffic to the products being advertised.

Another object of the disclosure is to provide an advertisement creation and publishing system, process and method of use that integrates efficiently with application programming interfaces.

Yet another object of the disclosure is to provide an advertisement creation and publishing system, process and method of use that designs advertisements.

Another object of the disclosure is to provide an advertisement creation and publishing system, process and method of use that creates advertisements.

Yet another object of the disclosure is to provide an advertisement creation and publishing system, process and method of use that launches advertisements.

Another object of the disclosure is to provide an advertisement creation and publishing system, process and method of use that works with a single click.

Yet another object of the disclosure is to provide an advertisement creation and publishing system, process and method of use that monitors performance of advertisements.

Another object of the disclosure is to provide an advertisement creation and publishing system, process and method of use that optimizes performance of advertisements.

Yet another object of the disclosure is to provide an advertisement creation and publishing system, process and method of use that optimizes bids and budgets associated with advertisements and marketing campaigns.

Another object of the disclosure is to provide an advertisement creation and publishing system, process and method of use that utilizes machine learning.

Yet another object of the disclosure is to provide an advertisement creation and publishing system, process and method of use that employs advertisements and advertisement campaigns in a manner of sustained success.

Another object of the disclosure is to provide an advertisement creation and publishing system, process and method of use that works across multiple advertising platforms.

Yet another object of the disclosure is to provide an advertisement creation and publishing system, process and method of use that can auto-generate advertisements based on the products listed on a platform.

Another object of the disclosure is to provide an advertisement creation and publishing system, process and method of use that includes dynamic templates.

Yet another object of the disclosure is to provide an advertisement creation and publishing system, process and method of use that utilizes dynamic templates to produce a variety of textual and visual differences across various advertisements.

Another object of the disclosure is to provide an advertisement creation and publishing system, process and method of use that can accept new templates.

Yet another object of the disclosure is to provide an advertisement creation and publishing system, process and method of use that can create dynamic arrangements.

Another object of the disclosure is to provide an advertisement creation and publishing system, process and method of use that can target particular audiences.

Yet another object of the disclosure is to provide an advertisement creation and publishing system, process and method of use that is adaptable.

Another object of the disclosure is to provide an advertisement creation and publishing system, process and method of use that continues to monitor advertisements performances after launch.

Yet another object of the disclosure is to provide an advertisement creation and publishing system, process and method of use that curtails spending on low performing advertisements.

Another object of the disclosure is to provide an advertisement creation and publishing system, process and method of use that requires only a single click.

Yet another object of the disclosure is to provide an advertisement creation and publishing system, process and method of use that is user friendly.

Another object of the disclosure is to provide an advertisement creation and publishing system, process and method of use that is easy to use.

Yet another object of the disclosure is to provide an advertisement creation and publishing system, process and method of use that is intuitive.

Another object of the disclosure is to provide an advertisement creation and publishing system, process and method of use that is labor free.

Yet another object of the disclosure is to provide an advertisement creation and publishing system, process and method of use that is not repetitive.

Another object of the disclosure is to provide an advertisement creation and publishing system, process and method of use that can launch advertisements for multiple products with a single click.

Yet another object of the disclosure is to provide an advertisement creation and publishing system, process and method of use that allows users to scale existing product advertisements out to hundreds, or more, of different variations.

Another object of the disclosure is to provide an advertisement creation and publishing system, process and method of use that can dynamically modify components of a graphic design or advertising graphics.

Yet another object of the disclosure is to provide an advertisement creation and publishing system, process and method of use that can dynamically adapt the coloring, imagery, and/or other product needs and/or orientations of advertisements.

Another object of the disclosure is to provide an advertisement creation and publishing system, process and method of use that allows a user to create an advertisement from various products or platforms.

Yet another object of the disclosure is to provide an advertisement creation and publishing system, process and method of use that allows a user to modify individual advertisements.

Another object of the disclosure is to provide an advertisement creation and publishing system, process and method of use that allows a user to take a single advertisement design as input and create hundreds, if not more, of different variations of advertisements, each tailored to the needs of a platform or multiple product lines.

Yet another object of the disclosure is to provide an advertisement creation and publishing system, process and method of use that can perform the functions herein and more with a single click of a mouse.

Another object of the disclosure is to provide an advertisement creation and publishing system, process and method of use that can pull advertisement information from an e-commerce platform.

Yet another object of the disclosure is to provide an advertisement creation and publishing system, process and method of use that provides a comprehensive database capable of containing a myriad of information including, but not limited to, styling, imagery, coloration, and other legal needs of an e-commerce platform.

Another object of the disclosure is to provide an advertisement creation and publishing system, process and method of use that can utilize machine learning to learn various rules and/or gain intimate knowledge of the needs of a platform.

Yet another object of the disclosure is to provide an advertisement creation and publishing system, process and method of use that does not require a user to have advertising knowledge.

Another object of the disclosure is to provide an advertisement creation and publishing system, process and method of use that allows any input file to be applied to any e-commerce platform.

Yet another object of the disclosure is to provide an advertisement creation and publishing system, process and method of use that provides rapid assimilation of a platform.

Another object of the disclosure is to provide an advertisement creation and publishing system, process and method of use that provides near instant use with any new platform.

Yet another object of the disclosure is to provide an advertisement creation and publishing system, process and method of use that improves upon the state of the art.

Another object of the disclosure is to provide an advertisement creation and publishing system, process and method of use that is easy to use.

Yet another object of the disclosure is to provide an advertisement creation and publishing system, process and method of use that is quick and efficient.

Another object of the disclosure is to provide an advertisement creation and publishing system, process and method of use that is accurate.

Yet another object of the disclosure is to provide an advertisement creation and publishing system, process and method of use that can, be widely used.

Another object of the disclosure is to provide an advertisement creation and publishing system, process and method of use that can be used in a variety of ways.

Yet another object of the disclosure is to provide an advertisement creation and publishing system, process and method of use that is robust.

Another object of the disclosure is to provide an advertisement creation and publishing system, process and method of use that saves time for a user.

Yet another object of the disclosure is to provide an advertisement creation and publishing system, process and method of use that saves capital for a user.

Another object of the disclosure is to provide an advertisement creation and publishing system, process and method of use that is fun to use.

Yet another object of the disclosure is to provide an advertisement creation and publishing system, process and method of use that is high quality.

Another object of the disclosure is to provide an advertisement creation and publishing system, process and method of use that is easy to use.

Yet another object of the disclosure is to provide an advertisement creation and publishing system, process and method of use that is efficient.

Another object of the disclosure is to provide an advertisement creation and publishing system, process and method of use that provides ongoing machine monitoring.

Yet another object of the disclosure is to provide an advertisement creation and publishing system, process and method of use that provides ongoing machine adaptation and machine learning.

Another object of the disclosure is to provide an advertisement creation and publishing system, process and method of use that provides variation mutli-variate testing.

Yet another object of the disclosure is to provide an advertisement creation and publishing system, process and method of use that provides source design for variation multi-variate testing.

Another object of the disclosure is to provide an advertisement creation and publishing system, process and method of use that provides brand compliance features.

Yet another object of the disclosure is to provide an advertisement creation and publishing system, process and method of use that provides for storage and staging areas for source designs.

Another object of the disclosure is to provide an advertisement creation and publishing system, process and method of use that can apply datasets to an alpha channel layer of a design.

Yet another object of the disclosure is to provide an advertisement creation and publishing system, process and method of use that provides for trademark checking.

Another object of the disclosure is to provide an advertisement creation and publishing system, process and method of use that provides for automatic trademark checking.

These and other objects, features, or advantages of the present disclosure will become apparent from the specification and claims.

### BRIEF DESCRIPTION OF THE DRAWINGS

FIG. 1 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature;

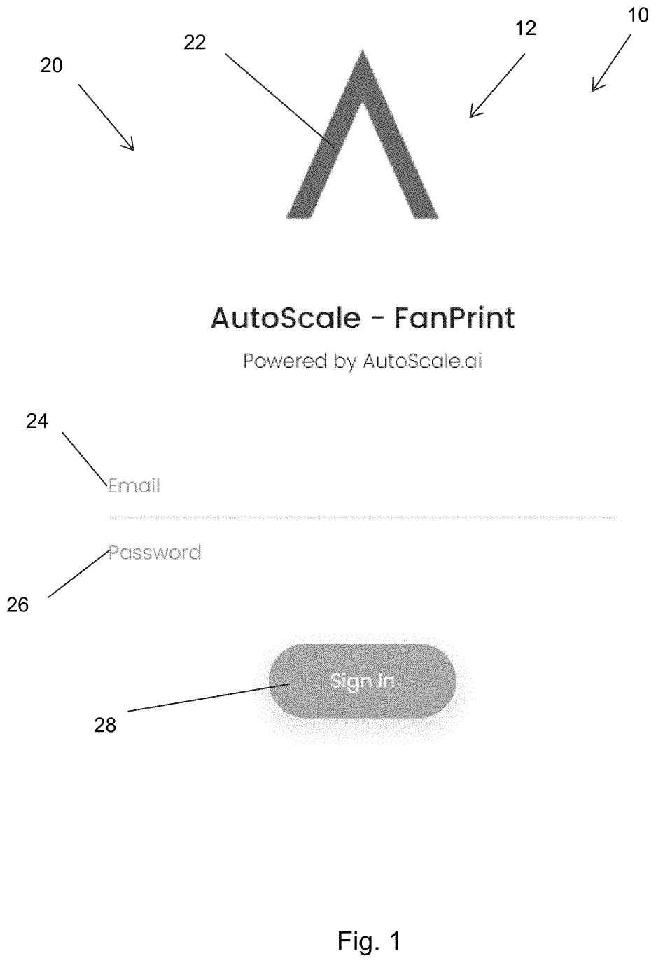

FIG. 2 is a diagram illustrating the advertisement creation and publishing system, processes and methods of use; the diagram illustrating an advertisement creation and publishing system; the diagram illustrating the advertisement creation and publishing system having, a graphical user interface; the diagram illustrating the graphical user interface having a login feature; the diagram illustrating the graphical user interface having, an accounts feature; the diagram illustrating a home feature; the diagram illustrating a plurality of tabs; the diagram illustrating an automation tab; the diagram illustrating an automation page; the diagram illustrating a plurality of features and components associated with the automation page;

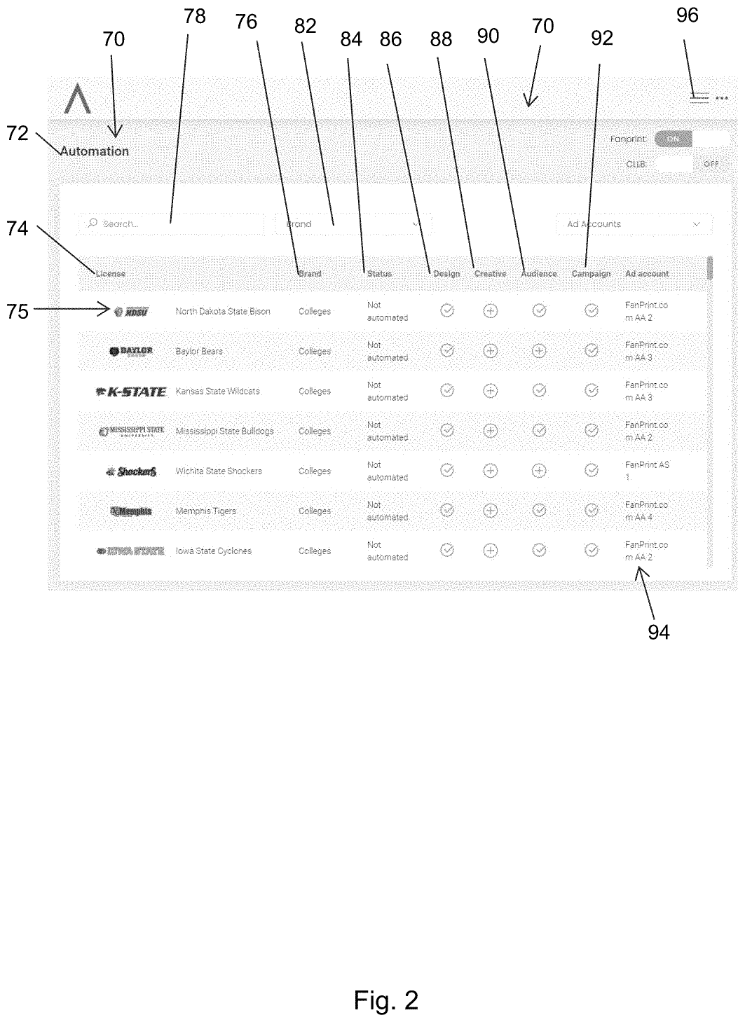

FIG. 3 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an ad accounts page; the diagram illustrating a plurality of features and components associated with the ad accounts feature;

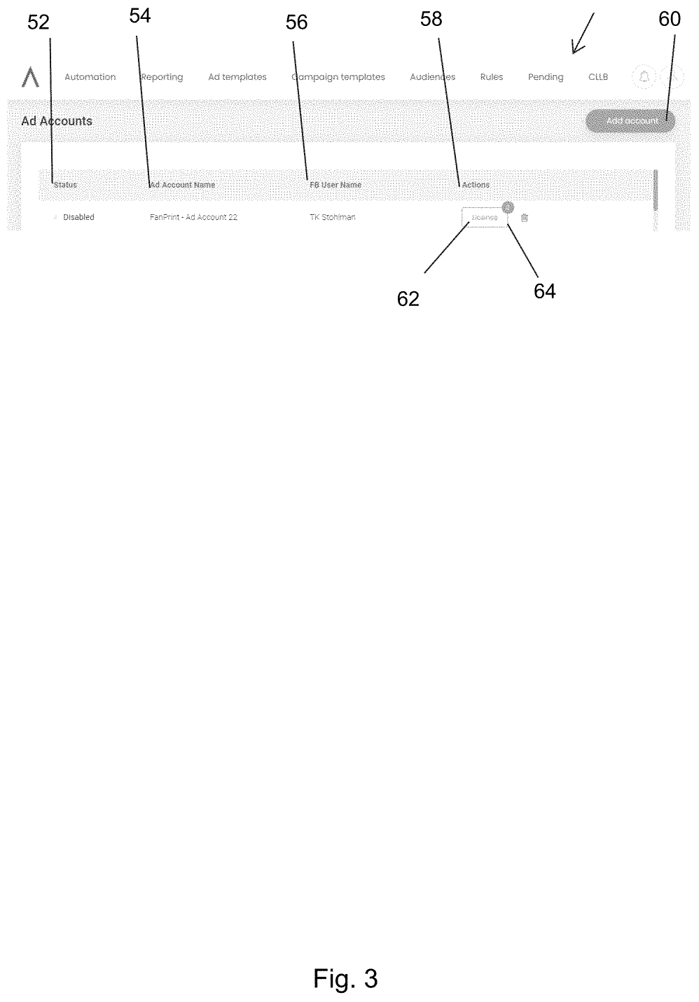

FIG. 4 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature: the diagram illustrating a home feature; the diagram illustrating a plurality of tabs; the diagram illustrating an ad accounts window feature; the diagram illustrating a plurality of features and components associated with the connect ad accounts feature;

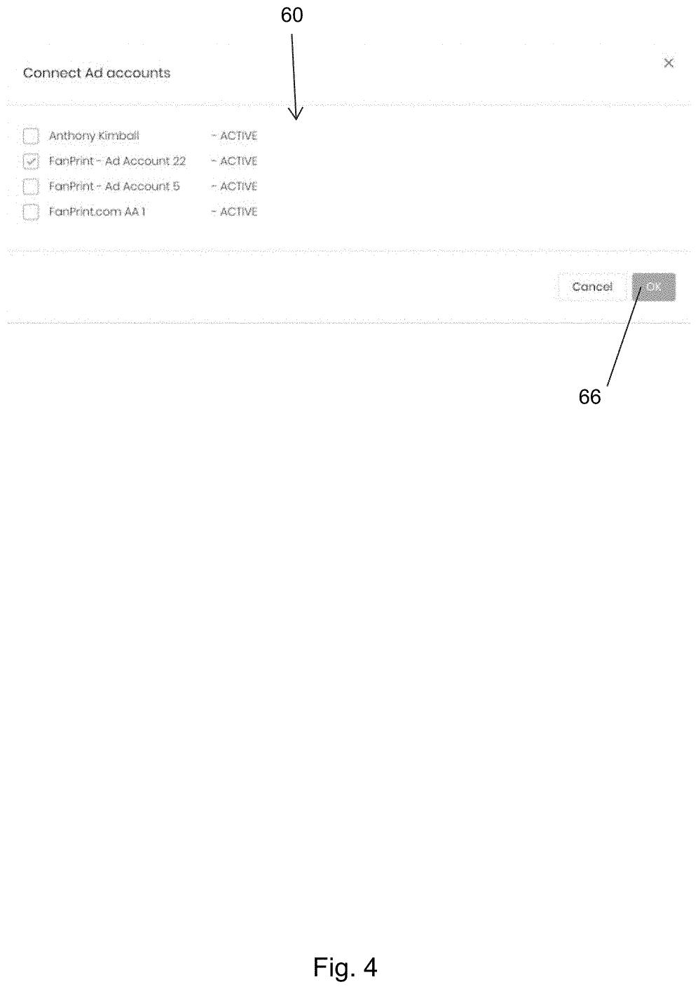

FIG. 5 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an ad templates tab; the diagram illustrating an ad templates page; the diagram illustrating a plurality of features and components associated with the design template selection feature;

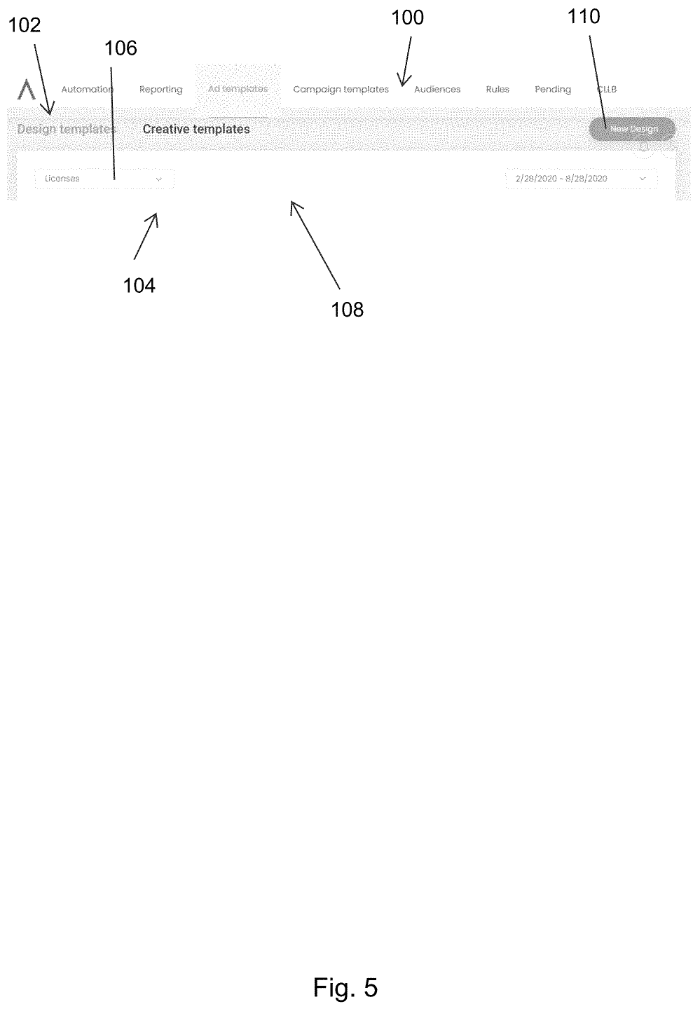

FIG. 6 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an ad templates tab; the diagram illustrating an create template; the diagram illustrating a plurality of features and components associated with the create template feature;

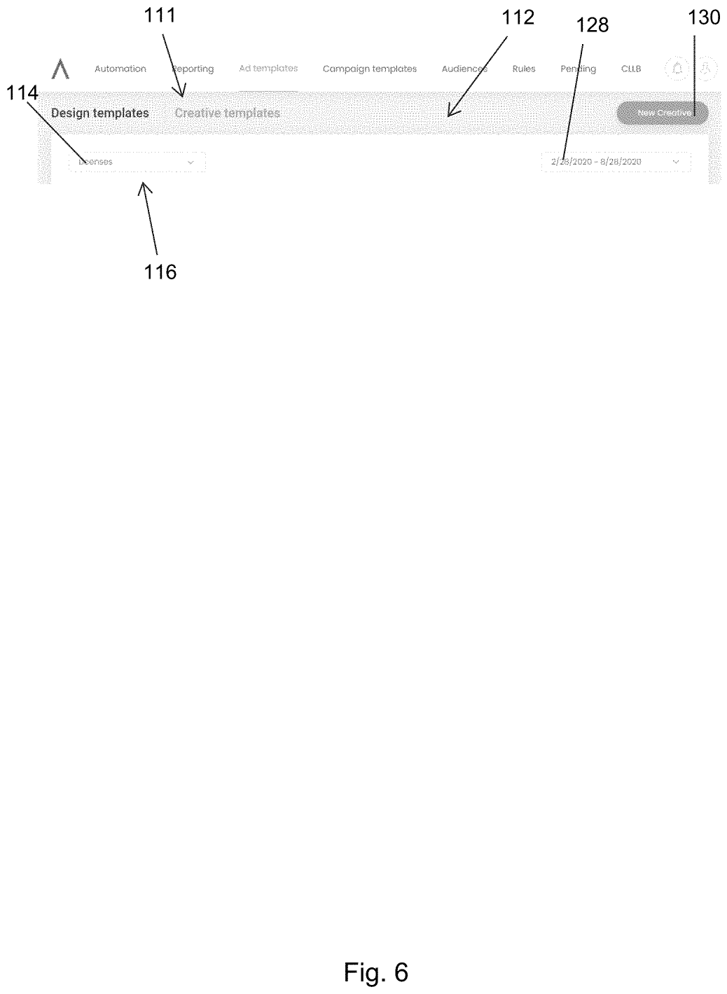

FIG. 7 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having, an accounts feature; the diagram illustrating a home feature; the diagram illustrating a plurality of tabs; the diagram illustrating an ad templates tab; the diagram illustrating an create template; the diagram illustrating a plurality of features and components associated with the create template feature; the diagram illustrating a create template window;

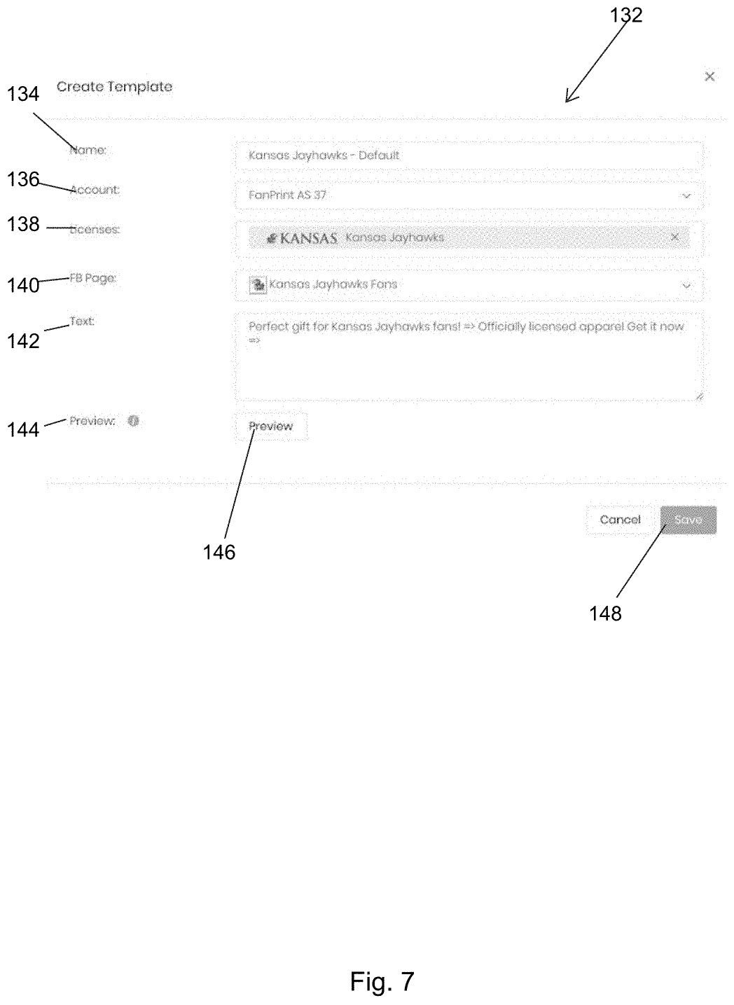

FIG. 8 is a diagram illustrating the advertisement creation and publishing system, processes and methods of use; the diagram illustrating an advertisement creation and publishing system; the diagram illustrating the advertisement creation and publishing system having, a graphical user interface; the diagram illustrating the graphical user interface having a login feature; the diagram illustrating the graphical user interface having, an accounts feature; the diagram illustrating a home feature; the diagram illustrating a plurality of tabs; the diagram illustrating an campaign template tab; the diagram illustrating an campaign template page; the diagram illustrating a plurality of features and components associated with the campaign template feature;

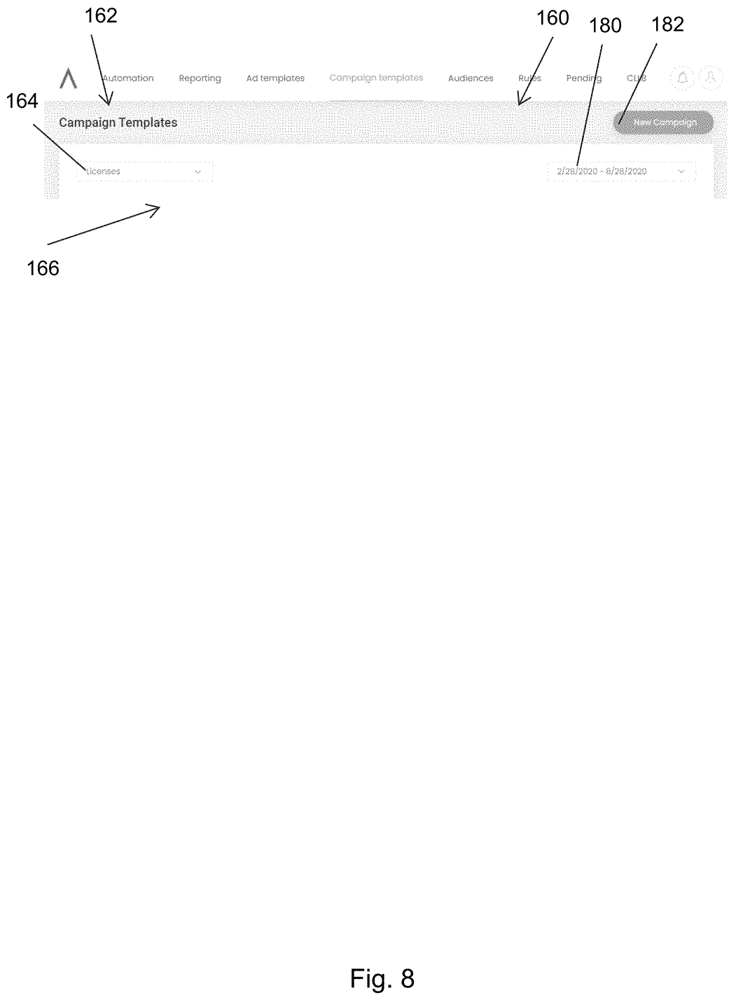

FIG. 9 is a diagram illustrating the advertisement creation and publishing system, processes and methods of use; the diagram illustrating an advertisement creation and publishing system; the diagram illustrating the advertisement creation and publishing system having, a graphical user interface; the diagram illustrating the graphical user interface having a login feature; the diagram illustrating the graphical user interface having, an accounts feature; the diagram illustrating a home feature; the diagram illustrating a plurality of tabs; the diagram illustrating a create template tab; the diagram illustrating an create template; the diagram illustrating a plurality of features and components associated with the create template window;

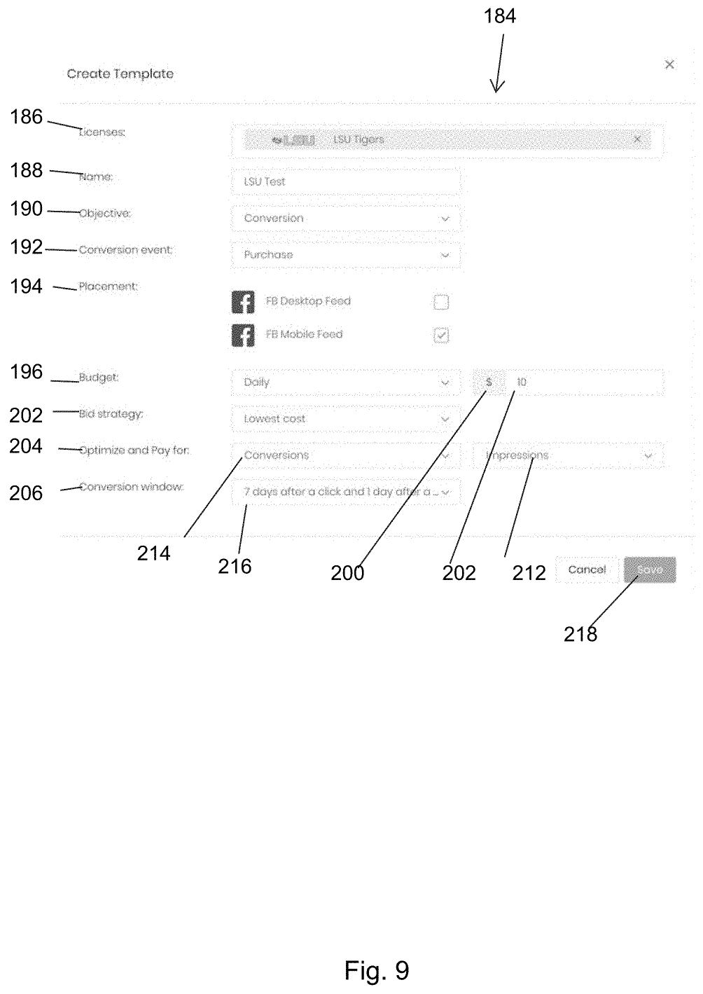

FIG. 10 is a diagram illustrating the advertisement creation and, publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an audience tab; the diagram illustrating an audience page; the diagram illustrating a plurality of features and components associated with the audiences feature;

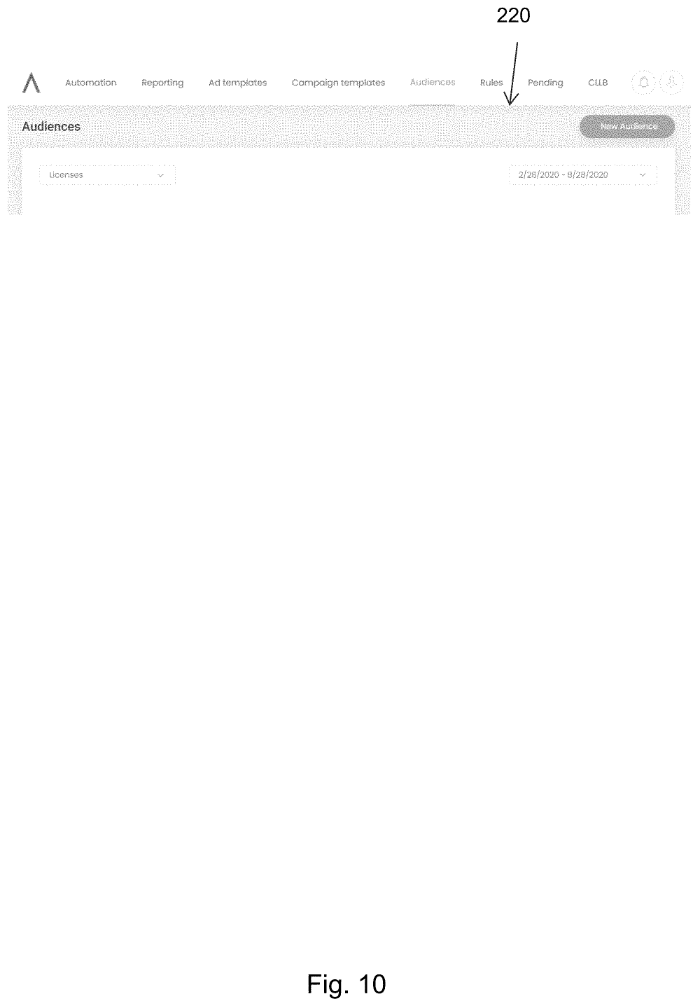

FIG. 11 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating a create template tab; the diagram illustrating an create template; the diagram illustrating a plurality of features and components associated with the create template window;

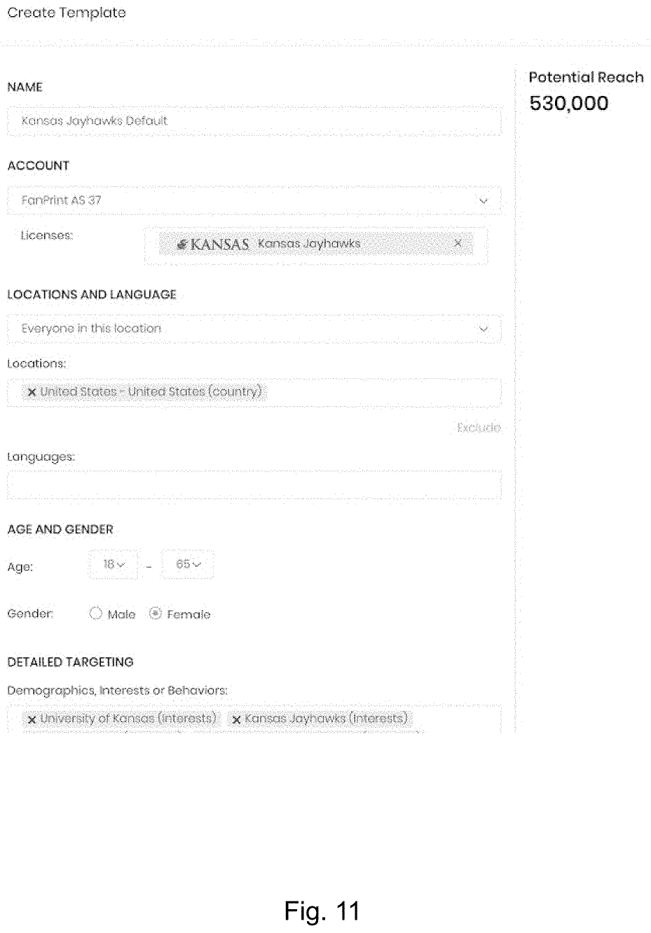

FIG. 12 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an target audience tab; the diagram illustrating a targeting feature; the diagram illustrating a plurality of features and components associated with the targeting feature window;

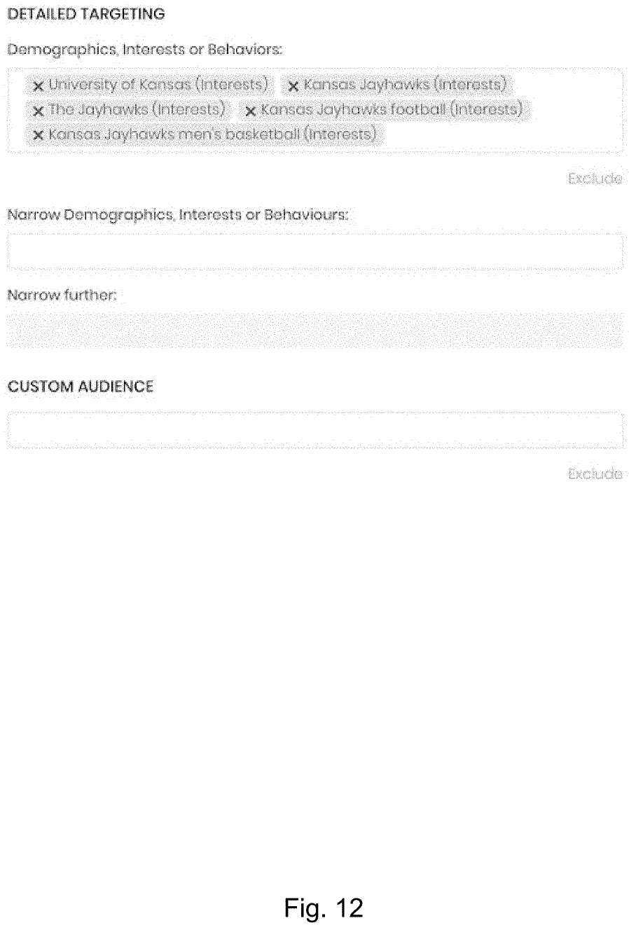

FIG. 13 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an rules tab; the diagram illustrating a rules feature; the diagram illustrating a plurality of features and components associated with the rules tab;

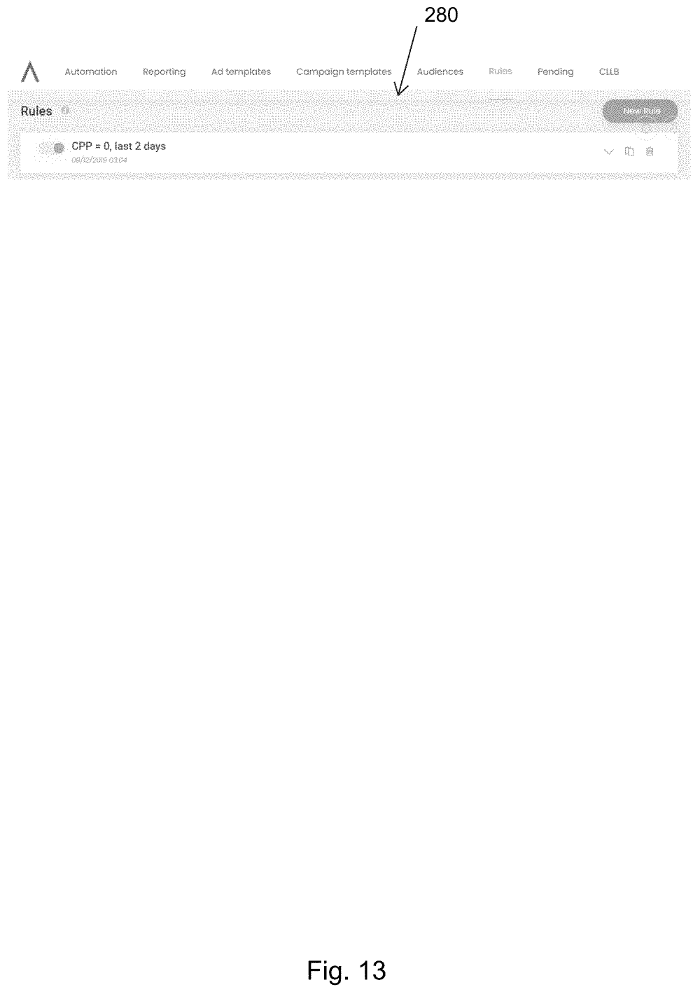

FIG. 14 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts featuie; the diagram illustrating a home feature; the diagram illustrating a plurality of tabs; the diagram illustrating an rules tab; the diagram illustrating a rules feature; the diagram illustrating a plurality of features and components associated with the rules tab; the diagram illustrating components and features associated with a rule;

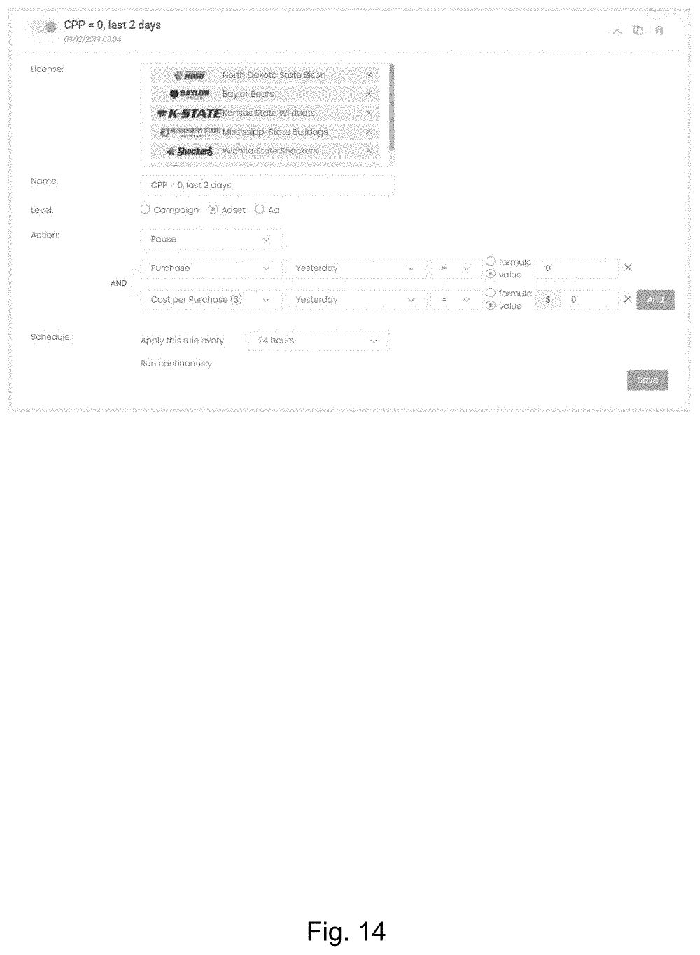

FIG. 15 is a diagram illustrating the advertisement creation and, publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having an accounts feature; the diagram illustrating a home feature; the diagram illustrating a plurality of tabs; the diagram illustrating an rules tab; the diagram illustrating a rules feature; the diagram illustrating a plurality of features and components associated with the rules tab; the diagram illustrating components and features associated with a rule;

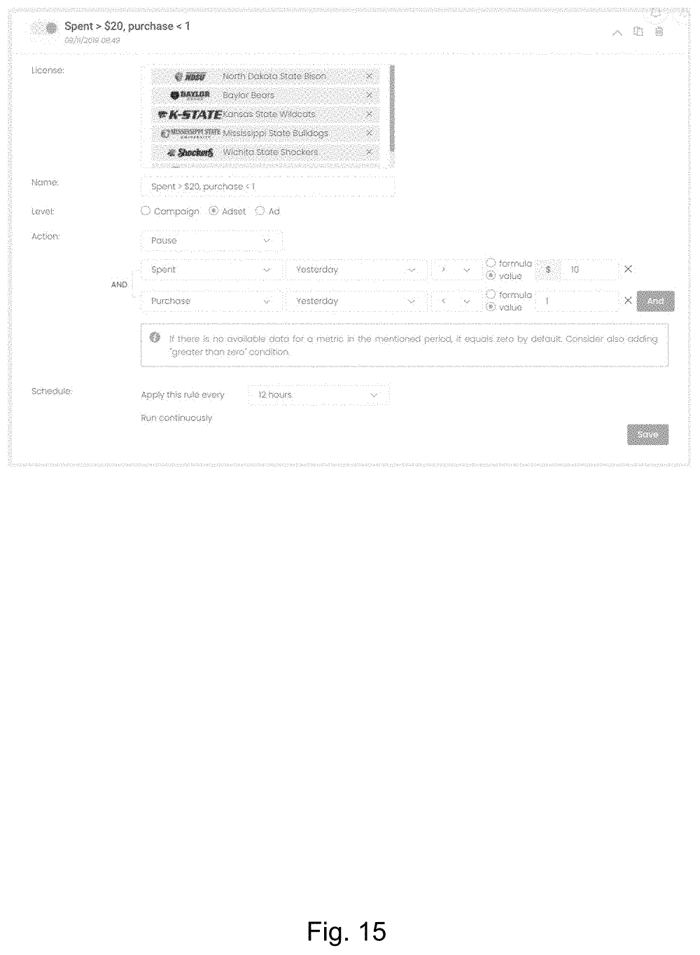

FIG. 16 is a diagram illustrating the advertisement creation and, publishing system, processes and methods of use; the diagram illustrating an advertisement creation and publishing system; the diagram illustrating the advertisement creation and publishing system having a graphical user interface; the diagram illustrating the graphical user interface having a login feature; the diagram illustrating the graphical user interface having a pending rules feature; the diagram illustrating a plurality of tabs; the diagram illustrating pending campaign tab; the diagram illustrating a pending campaign feature; the diagram illustrating a plurality of features and components associated with the pending campaign tab; the diagram illustrating components and features associated with a pending campaign;

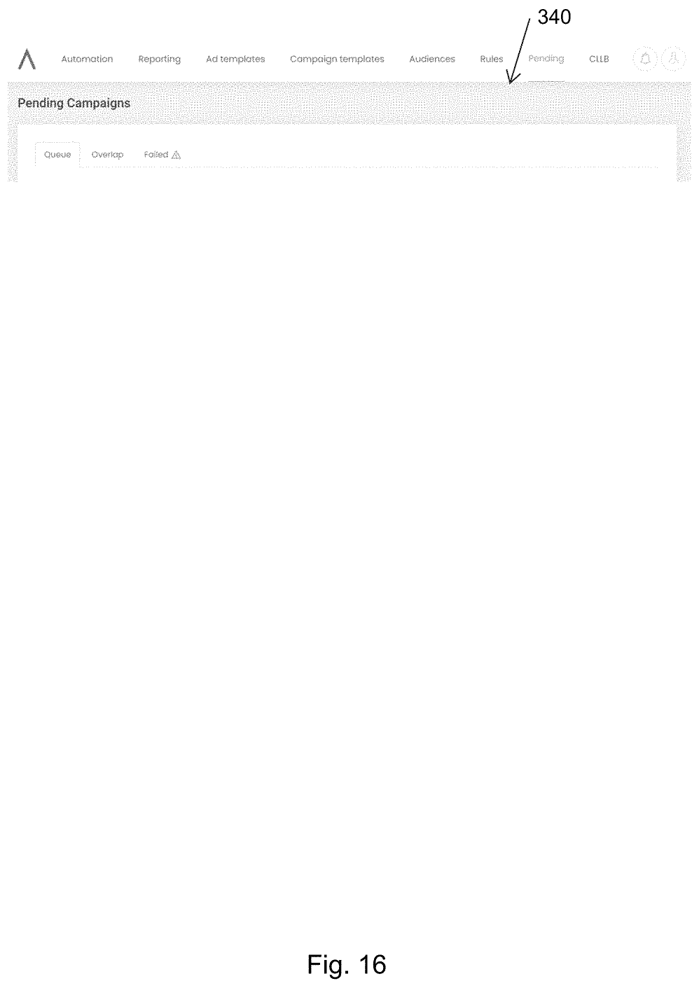

FIG. 17 is a diagram illustrating the advertisement creation and, publishing system, processes and methods of use; the diagram illustrating an advertisement creation and publishing system; the diagram illustrating the advertisement creation and publishing system having a graphical user interface; the diagram illustrating the graphical user interface having a campaign;

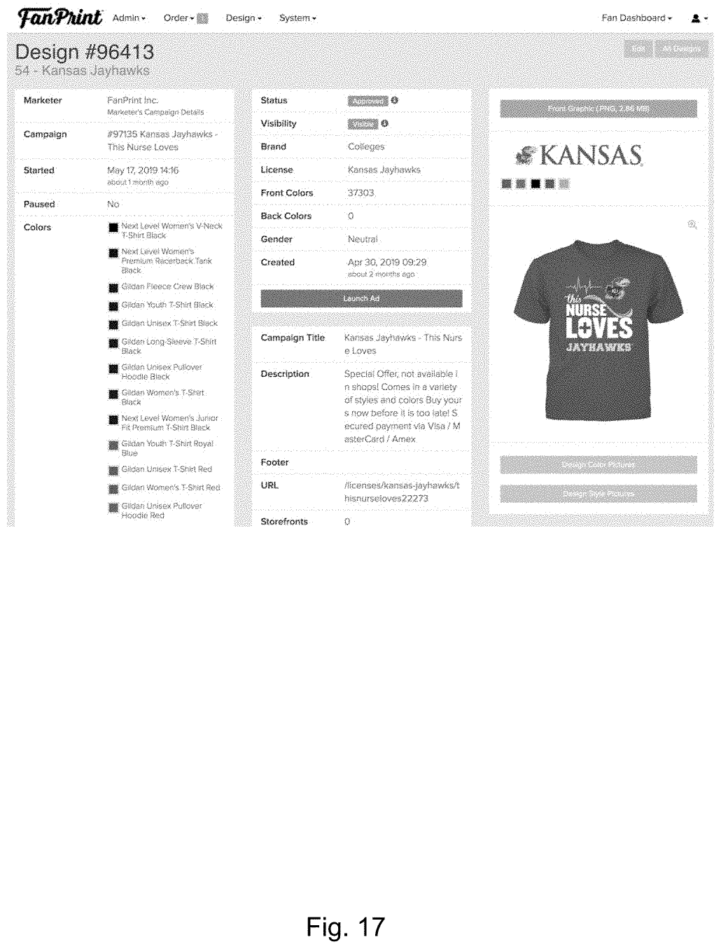

FIG. 18 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a campaign;

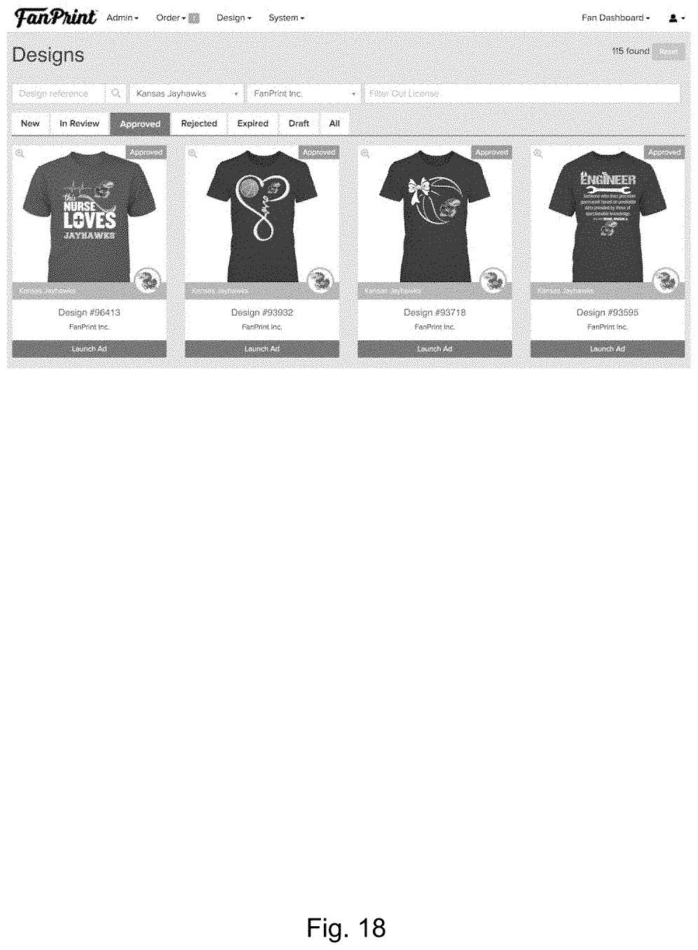

FIG. 19 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a ad summary feature; the diagram illustrating a plurality of features and components associated with the ad summary tab;

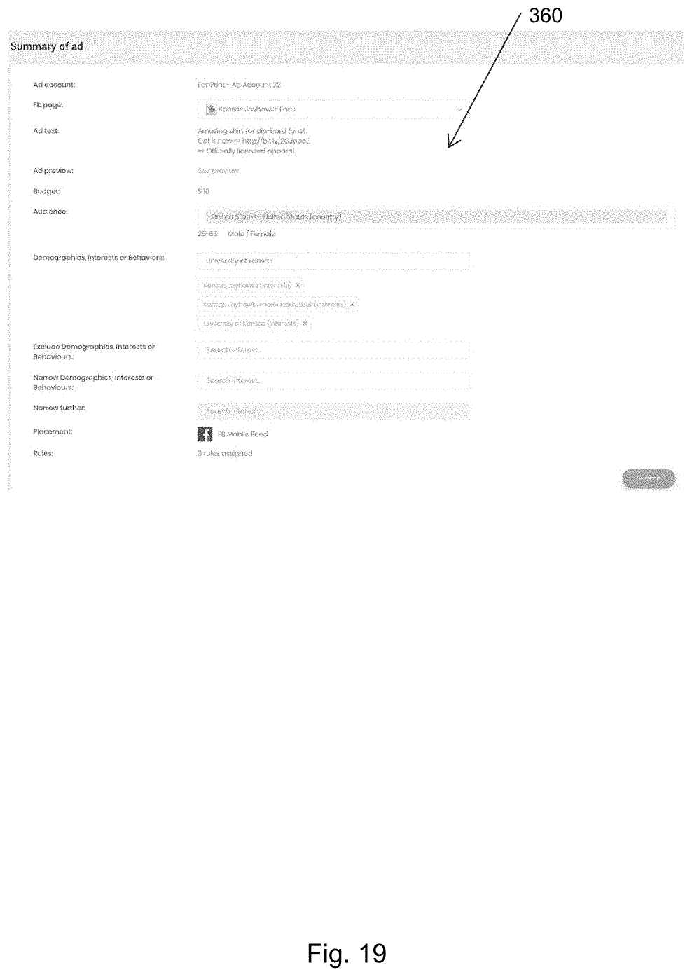

FIG. 20 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a ad summary feature; the diagram illustrating a plurality of features and components associated with the ad summary tab;

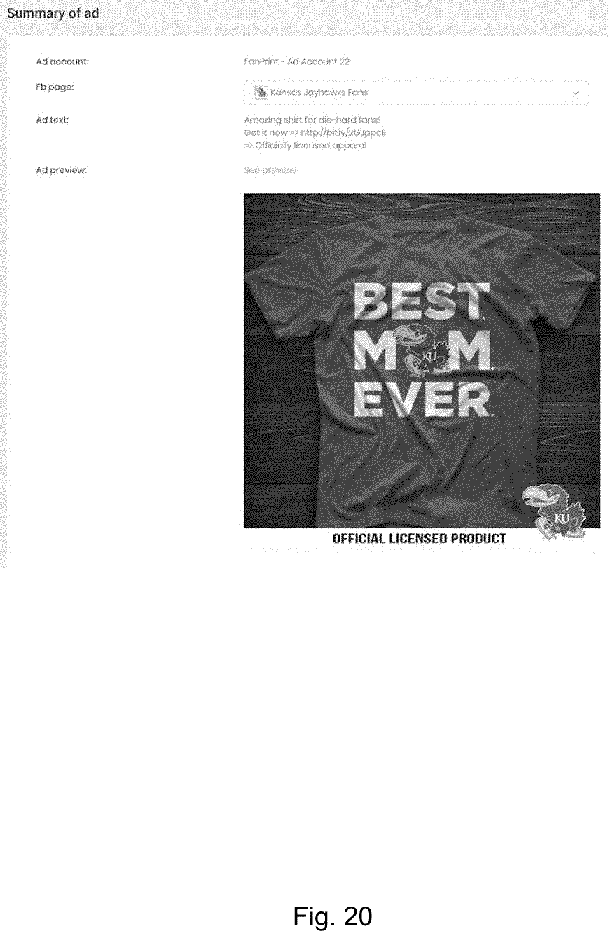

FIG. 21 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a ad summary feature; the diagram illustrating a plurality of features and components associated with the ad summary tab;

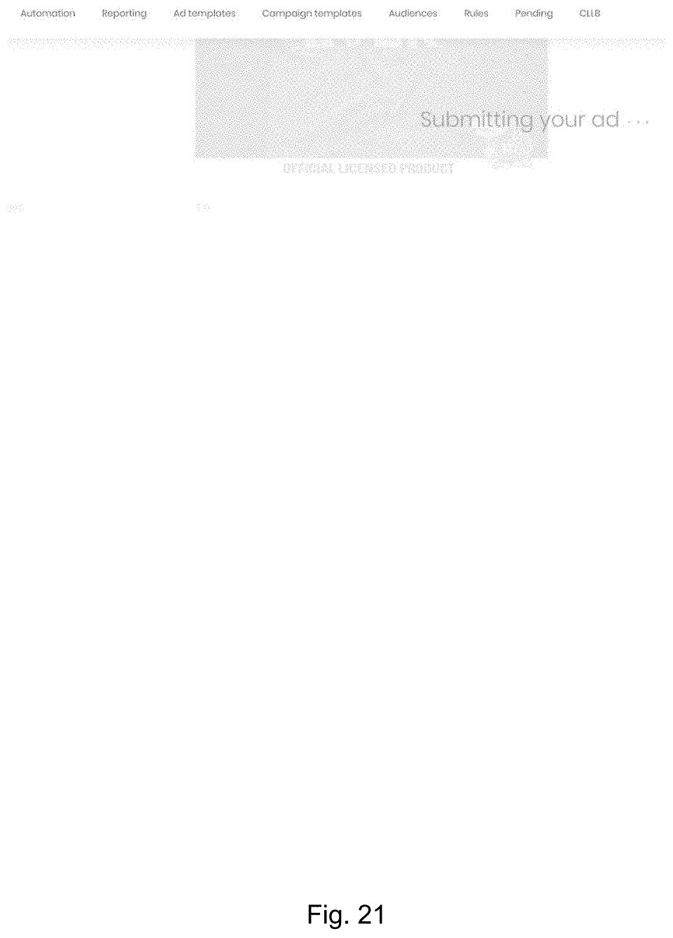

FIG. 22 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a ad management feature; the diagram illustrating a plurality of features and components associated with the ad management tab;

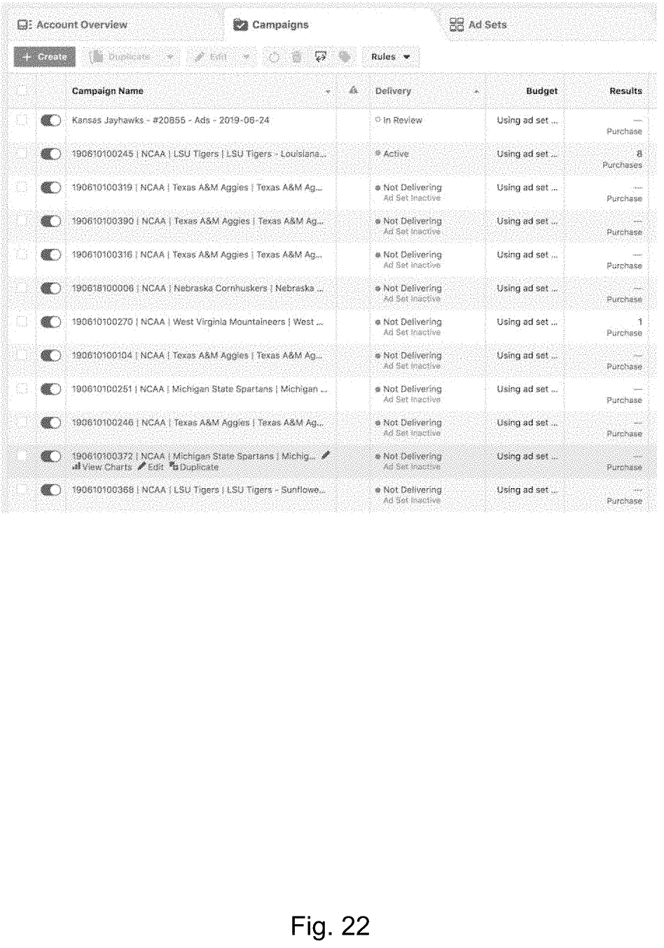

FIG. 23 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a ad summary feature; the diagram illustrating a plurality of features and components associated with the ad summary tab;

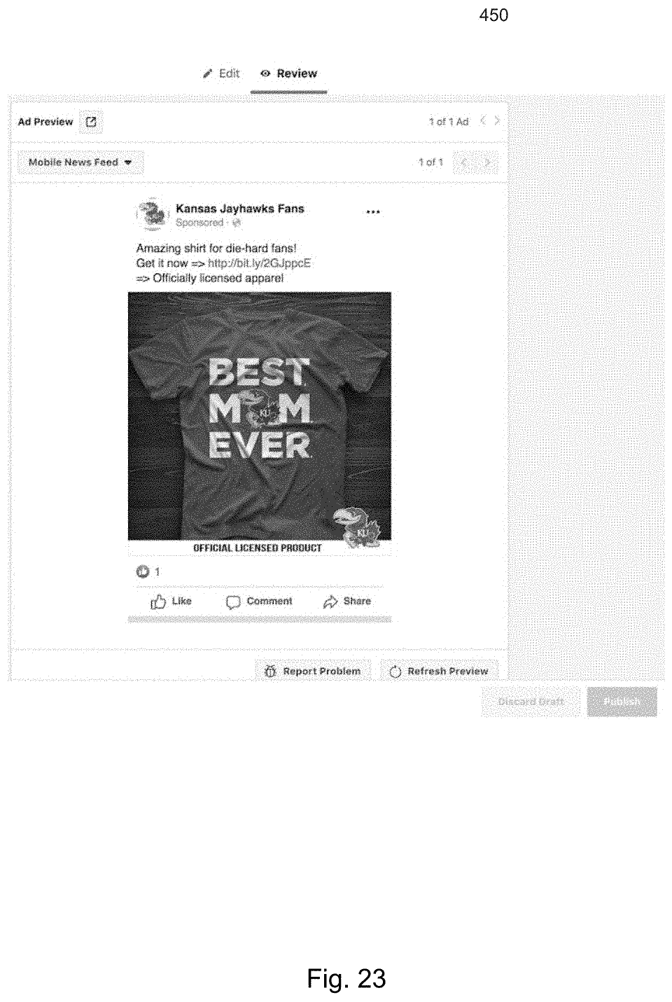

FIG. 24 is a diagram illustrating the advertisement creation and publishing system, processes and methods of use; the diagram illustrating an advertisement creation and publishing system; the diagram illustrating the advertisement creation and publishing system having a graphical user interface; the diagram illustrating the graphical user interface having a reporting feature; the diagram illustrating a plurality of features and components associated with the reporting feature;

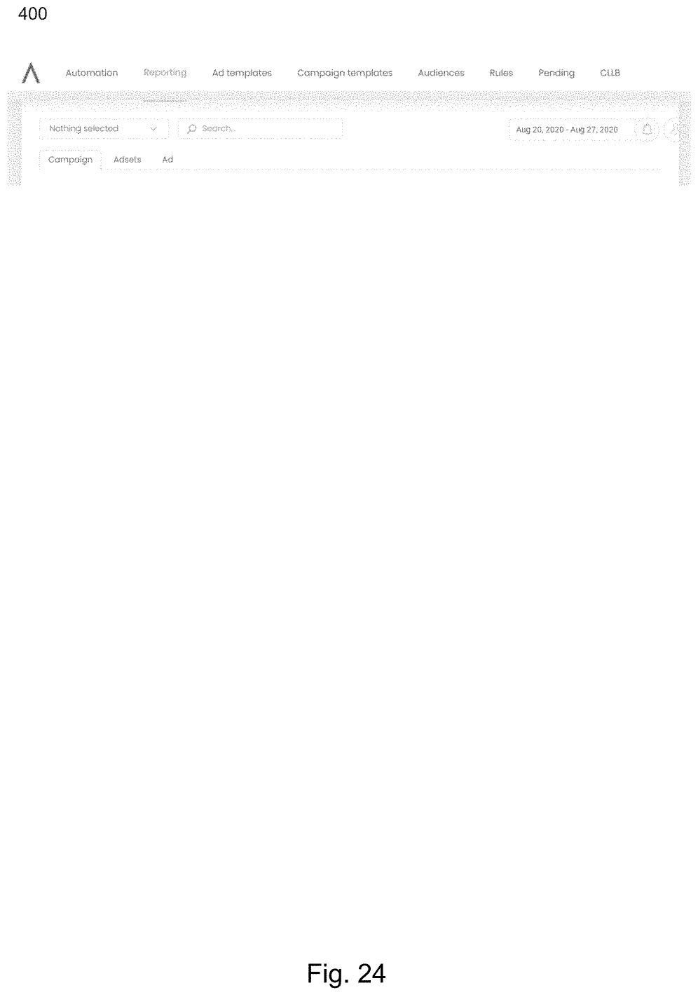

FIG. 25 is a diagram illustrating the advertisement creation and publishing system, processes, and methods of use; the diagram illustrating a method of use of the advertisement creation system.

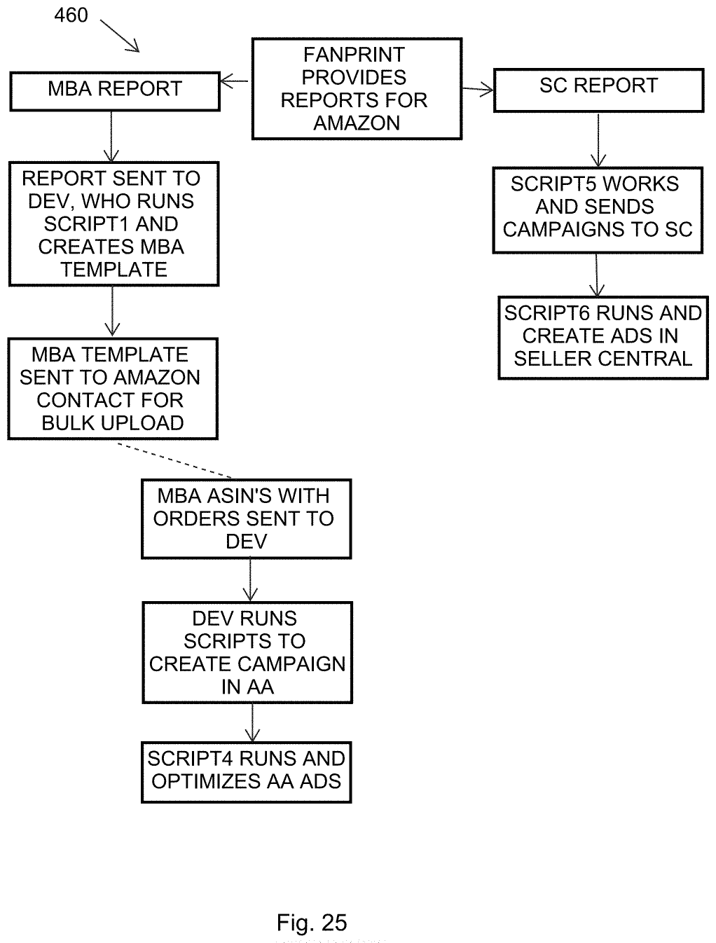

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart anchor block diagram block or blocks.

Advertisement creation and publishing system (also known as “advertisement system”), process and method of use is configured to increase the convenience for sponsors in designing, creating, launching, and maintaining advertisements and/or advertising campaigns. Advertising system is configured to integrate with e-commerce platforms to allow users to design, create, and launch ads and/or advertisement campaigns, based on a product, of different variations by dynamically modifying components of the graphic design of the advertisement to allow into adapt to the coloring, imagery, and other needs of each different brand and/or sponsor. By allowing a user to input a graphic design in its component parts, advertising system is able to modify each feature of an advertisement in part individually, tailoring it to the styling of the user, if desired. In this way, advertising system can take a single design concept as input and create hundreds, or more, of different versions of advertisements, each tailored to the needs of the user, in a matter of minutes, or even less.

Embodiments of the present disclosure include systems and methods that automatically pull some or all product information from a platform and store this information and/or data in a comprehensive database containing a myriad of information about the styling, imagery, coloration, and other legal needs of each product and/or brand.

Furthermore, advertising system, for the first time, allows a user with no marketing knowledge, to design, create, and launch an advertisement and/or advertisement campaign on a platform, or a variety of platforms, based on one product, or multiple products. In other words, a user can generate thousands of different advertisements catering to a specific audience without having an intimate knowledge of the needs of the brand and or sponsor. Furthermore, advertising system can retrieve data for any product and/or input file, automatically create a dataset based on that product in a database, and apply various property data to any amount of properties configured in a database.

System:

With reference to the figures, an advertisement creation and publishing system 10, process, and method of use is presented (hereafter known as “advertisement system” or simply “system”). Advertisement system 10 is formed of any suitable size, shape and design. In the arrangement shown, as one example, system 10, which may comprise remote servers, databases, application servers, application databases, application programming interfaces, product databases, mobile applications, and/or computers that fulfill the functions disclosed herein, also includes, in the embodiment depicted, a graphical user interface 12, a database 14, a plurality of datasets 16, a plurality of licenses 17, and accounts 18, among other components.

In the arrangement shown, as one example, system 10 comprises remote servers, databases, and/or computers that fulfill the functions disclosed and, described herein. In the embodiment depicted, system 10 comprises an application server 460. Application server 460 comprises one or more computer systems adapted to transmit and receive data regarding selected datasets related to various users and/or datasets related to multiple users. Application server 460 is adapted to query database with unique identification codes to retrieve a list of brand and/or product and/or license rules related to various users. Application server 460 may transmit product data related to layers and rules with respect to a single user and/or multiple users. Application server 460 is also adapted to query a product database 464. This query includes receiving and sending product identification codes and product data. Additionally, application server 460 may communicate with a mobile application 476, which is adapted to present the product information in a form conducive to being viewed on a mobile device and/or handheld device.

The appearance of the presentation of the product information and/or the process windows for creating hundreds of designs from a single template may be customized with data of particular relevance to the customer and the retail store at which the customer is most likely to be creating merchandise for. As one example, the appearance of windows and/or the process for creating hundreds of designs may be customized for pricing information, shipping location, and/or other information related merchandise and designs.

As one of ordinary skill in the art may understand, application server 460, product database 464, and other databases mentioned herein may be implemented in one or more servers. Furthermore, each may be on multiple servers to increase system efficiency, especially when handling lame data gathering, following extended rules for brands and/or user and generating hundreds of designs at once from a single template. Additionally, multiple servers may have mirrored data to prevent data loss in case of disk failure and/or to decrease access and response times for database queries. In alternative embodiments, application server 464, and other database procedures may be carried out on computer-readable instructions and data stored on the customer's mobile computing device. Additionally, system 10 includes an application programming interface 462 (“API”) which includes tools and resources enabling a user to operate the embodiments herein.

Graphical User Interface:

In the arrangement shown, as one example, system 10 includes a graphical user interface 12. Graphical user interface 12 is formed of any suitable size shape and design and is configured to guide a user through the advertisement and/or advertisement campaign creation and launch process including creating a design template 484, uploading information to a database as necessary, retrieving product information as necessary, previewing advertisements, and auto-generating advertisements from a single design template. Graphical user interface 12 is an exemplary method by which systems of the present disclosure may create hundreds, if not more, various designs of advertisements 486 and/or advertisement campaigns 488 from a single design template 484. Using graphical user interface 12, a user creates a single design with desired products, from the single creation, system 10 generates hundreds, or more advertisements.

In the arrangement shown, as one example, graphical user interface 12 includes accounts 18, a plurality of page links 19, a login page 20, a home page 30, an ad accounts page 50, an automation page 70, an ad templates page 100, a campaign page 160, an audience page 220, a rules page 280, a summary of ad page 360, a reporting page 400, and may also include an account link 13, among other components.

In this arrangement, as one example, a sponsor or other user accesses their account 18 via a login page 20, is the entrance page to the graphical user interface 12. Login page 20 serves the purpose of computer security, and is the page through which a sponsor and/or user gains access to system 10 by identifying and authenticating themselves. In the arrangement shown, as one example, login page 20 includes a display 22, a username 24, a password 26, a log in 28, among other components.

In the arrangement shown, as one example, system 10 also includes a home page 30. Home page 30 is formed of any suitable size, shape, and design and is configured to generally be the main page a user utilizes to navigate the website and/or graphical user interface 12. In addition, and in the arrangement shown, the home page 30 may also serve as a landing page, often times being the first page or a page by which a user lands after logging into their account 18. Additionally, the home page 30 provides a plurality of page links 19 and/or tabs 32.

Tabs 32 are formed of any suitable size, shape, and design and are configured to give the user a way to navigate the graphical user interface 12. In the arrangement shown, as one example, tabs 32 are arranged along the top of each various page and are designed to provide visual queues not only to what page the user is on but also to indicate to a user how far along they are in the process of creating hundreds of ads and/or advertisement campaigns. The plurality of tabs 32 includes an automation tab, a reporting tab, an ad templates tab, a campaign templates tab, an audiences tab, a rules tab, a pending tab, and a CLLR tab, among other tabs. In the arrangement shown, as one example, the tabs disclosed herein provide links to the associated pages. However, any other number of tabs or arrangement of tabs is hereby contemplated for use.

Ad Accounts Page: In the arrangement shown, as one example, graphical user interface 12 includes an Ad Accounts Page 50. Ad Accounts Page 50 is formed of any suitable size, shape, and design and is configured to help a sponsor and/or user manage accounts or access various ad accounts. In other words, the Ad Accounts Page 50 is configured to help a sponsor choose an ad account or switch between different ad accounts as well as disable or activate various accounts. Additionally, this feature is designed to supply other actions, such as deleting the advertisements accounts and/or launching previously disabled accounts. Additionally, in the Ad Accounts Page 50, a user can select the desired account/product and focus on a particular product, and complete other features such as disabling a product advertising in the event of sellout or any other event.

In the arrangement shown, as one example, Ad Accounts Page 50 includes a status 52, an Ad Account Name 54, a plurality of identifiers 56, actions 58, add account feature 60, other information feature 62, a platform identifier feature 64, a connect accounts feature 66, among other options, controls, features, and components.

Automation Page: In the arrangement shown, as one example, graphical user interface 12 includes an automation page 70. Automation page 70 is arranged in any size, shape, and design and is configured to serve as one of the main engagement pages of a user with the graphical user interface 12, The automation page 70 is configured to supply information to the user about various datasets, identify licenses, brands, statuses, and other information about the various automated features. In other words, the automation page 70 can clearly illustrate to a sponsor what active ad accounts have been designed, created, and campaigned and the status of the tabled or active advertisements and/or advertisement campaigns. The automation page also indicates if an active audience is being targeted, among other indications and features. In the automation page 70, in this way, a user can interact with a dataset by viewing, searching, modifying and/or retrieving information from the datasets, among other interactions.

In the arrangement shown, as one example, automation page 70 may include a tab indicator 72, a search feature 74, a dataset 75, a dataset selector 76, a dataset identifier 78, a license 80, a brand 82, a status 84, a design indicator 86, a creative feature 88, an audience identifier 90, a campaign identifier 92, a fanprint on/of selector 94, a CLLB on/off selector 96, and other on/off selectors, among other options, controls, and components.

Ad Templates Page: In the arrangement shown, as one example, graphical user interface 12 includes an ad templates page 100. Ad templates page 100 is formed of any suitable size, shape, and design and is configured to provide a list of templates by which ads and/or advertisement campaigns can be created for a plurality of products. In the arrangement shown, the ad templates page 100 includes two sub-pages, a design templates page 102 and a design templates sub-tab 101, and a create templates page 112.

In the arrangement shown, as one example, the design templates page 102 may be formed of any suitable size, shape and design and is configured to provide a list of design templates for advertisements and/or advertisement campaigns for use with various products. The design templates may be utilized based on the licenses available or other categories. Additionally, the design template page 102 includes a new design 110 which allows a user to generate and/or create and/or upload a new design template to be used in the ad creation. The design templates page 102 may also include a selector 104, licenses 106, and templates 108, among other options, controls, features, and components.

In the arrangement shown, as one example, the ad templates page 100 also includes a creative templates page 112 and creative templates sub-tab 111. Creative templates page 112 is formed of any suitable size, shape, and design and is configured to provide a list of creative templates for advertisements and/or advertisement campaigns for use with various products. The creative templates may be utilized based on the licenses available or other categories. Additionally, the creative templates page 112 allows a sponsor and/or user to take various actions with regards to a variety of creative templates. Additionally, the creative template page 112 includes a new creative 130 which allows a user to generate and/or create and/or upload a new creative template to be used in the ad creation. The creative templates page 112 may also include a selector feature 114, a licenses feature 116, a name identifier 118, an ad test feature 120, a license identifier feature 122, a date modified identifier 124, an actions feature 126, a date range identifier 128, and a new creative feature 130, among other options, controls, features, and components.

In the arrangement shown, the creative template page 112 includes a new creative template feature 130. Creative template feature 130 is formed of any suitable, size, shape and design is configured to aid a sponsor and/or user in creating a new creative template. In the arrangement shown, as one example, the new creative feature 130 opens a new window of which the creative template can be created. In the arrangement shown, the new creative feature 130 includes a create template window 132. The new creative feature 130 may also include a name identifier 134, an account 136, a license 138, a platform identifier 140, a text 142, a preview 144, a preview generator 146, and a save feature 148, among other options, controls, features, and components.

Campaign Page: In the arrangement shown, as one example, graphical user interface 12 includes a campaign page 160. Campaign page 160 is formed of any suitable size, shape, and design and is configured to provide interaction with the campaign template database as well as create new campaign templates. In other words, the campaign page 160 allows a user to see information about various active or inactive advertisement campaigns as well as create new advertisement campaigns from existing campaign templates or new campaign templates.

Among other options, controls, features, and components, the campaign page 160 may also include a campaign template 162, a selector 164, a license identifier 166, a campaign name 168, a license 170, a budget 172, a placement 174, a date modified identifier 176, an actions feature 178, a date range feature 180, and a new campaign feature 182, which opens a window to allow a sponsor to create a new campaign template.

In the arrangement shown, as one example, graphical user interface 12 may include a create campaign template window 184. Create campaign template window 184 is formed of any suitable size, shape, and design and is configured to provide to aid a sponsor and/or user in creating a new campaign template. Among other campaign features, create campaign template window 184 may include a license feature 186, a name feature 188, an objective 190, a conversion event 192, a placement 194, a budget 196, a frequency 198 a currency indicator 200, a currency amount 202, a big strategy 204, an optimization feature 206, various optimization options 208, conversions 210, impressions 212, a conversion window 214, various conversion window options 216, and a save feature, among other options, controls, features, and components.

Audiences Page: In the arrangement shown, as one example, graphical user interface 12 includes an audiences page 220. Audiences page 220 is formed of any suitable size, shape, and design and is configured to display and allow user interaction with the audiences dataset from the database. In other words, the audiences page 220 displays information to a sponsor about various advertisement campaigns including, but not limited to, the size of the audience the campaign is reaching, the name of the campaign, the location of the campaign, the licenses the campaign is utilizing, the age group the campaign is targeting, the gender the campaign is targeting, and more. In addition, the audiences page allows a user to take various actions in regards to various campaigns and/or advertisements. Additionally, the audience page allows a sponsor to create an advertisement and/or advertisement audience to target with any number of various licenses and/or brands and/or products.

In the arrangement shown, as one example, audiences page 220 includes a selector 222, a license identifier 224, a reach 226, a name 228, a location 230, a custom/lookalike 232, a license feature 234, an age 236, a gender 238, and various action features 240, a date range 242, and a new audience creator 244.

In the arrangement shown, graphical user interface 12 includes a new audience creator 244. New audience creator 244 is formed of any suitable size, shape, and design and is configured to create new audiences and/or audience templates that can be, saved and retrieved and used over and over again for various product ads and/or advertisement campaigns. New audience creator 244 includes an audience template creator window 246, a potential reach 248, a name 250, an account 252, a license 254, a location 256, a language selector 258, an age 260, a gender 262, a detailed targeting feature 264, an exclusion feature 266, a narrow demographics feature 268, a narrow additional feature 270, a custom audience 272, an exclude 274, and a save feature 276, among other options, controls, features and components.

Rules Page: In the arrangement shown, as one example, graphical user interface 12 includes a rules page 280. Rules page 280 is formed of any suitable size, shape, and design and is configured to display and allow user interaction with the rules dataset from the database. In other words, the rules page 280 displays information to a sponsor about various advertisement campaigns including, but not limited to, various rules the campaign may employ, including the name of the rule, whether the rule is employed, and more. In addition, the rules page 280 allows a user to take various actions in regards to various rules being utilized or not utilized in campaigns and/or advertisements. Additionally, the rules page 280 allows a sponsor to create a rule for an advertisement and/or advertisement campaign and/or product advertisement.

In the arrangement shown, as one example, rules page 280 includes a plurality of rules 282, a rules on/off 284, a rules date 286, options 288, a copy feature 290, a remove feature 292, and a new rule creator 294, among other options, controls, features, and components.

In the arrangement shown, graphical user interface 12 includes a new rule creator 294. New rule creator 294 is formed of any suitable size, shape, and design and is configured to create new rules and/or rule sets and/or rule templates that can be saved and retrieved and used over and over again for various product ads and/or advertisement campaigns. New rule creator 294 includes rule details 296, license information 298, name identifier 300, a campaign level 302, an ad set level 304, an ad level 306, an action 308, an action indicator 310, an action cost 312, an action frequency 314, an action formula 316, an action value 318, an action binary 320, a plurality of actions 321, a schedule 322, a frequency 324, a continuous selector 326, and a save feature among other options, controls, features and components.

Pending Page: In the arrangement shown, as one example, graphical user interface 12 includes a pending page 340. Pending page 340 is formed of any suitable size, shape, and design and is configured to display and allow user interaction with the pending campaigns dataset from the database. In other words, the pending page 340 displays information to a sponsor about various advertisement campaigns which are in the queue, which overlap, or which have failed.

In the arrangement shown, as one example, pending page 340 includes a list of pending campaigns 342, pending campaigns 343, a queue tab 344, a pending tab 346, an overlap tab 348, and a failed tab 350, among other options, controls, features, and components.

Summary of Ad Page: In the arrangement shown, as one example, graphical user interface 12 includes a summary of ad page 360. Summary of ad page 360 is formed of any suitable size, shape, and design and is configured to display and allow user interaction with a summary of information about an ad and/or advertisement campaign and/or product and/or ad account from the appropriate database. In other words, the summary of ad page 360 displays information to a sponsor about various ads and customizing options available for ads.

In the arrangement shown, as one example, summary of ad page 360 includes a customize feature 361, a potential reach 362, an add account identifier 364, a platform identifier 366, an ad text display 368, an ad preview 370, a preview viewer 372, a budget 374, an audience identifier 376, a demographics 378, a plurality of exclusions 380, a narrow demographics 382, a further limitations 384, a platform placements 386, a rule identifiers 388, a submit feature 390, and a submitting indicator 392, among other options, controls, features, and components.

Reporting Page: in the arrangement shown, as one example, graphical user interface 12 includes a reporting page 400. Reporting page 400 is formed of any suitable size, shape, and design and is configured to display and allow user interaction with a summary of information about an ad and/or advertisement campaign and/or product and/or ad account from the appropriate database. In other words, the reporting page 400 displays information to a report on one or all of the various ads and/or campaigns and/or rules and/or other ad sets which a sponsor may wish to view.

In the arrangement shown, as one example, reporting page 400 includes an ad selector 402, a search feature 404, a campaign tab 406, a campaign name 408, rules 410, status identifier 412, deliver identifier 414, a start date 416, a spent 418, a result 420, a reach 422, an impressions 424, a CPM 426, a clicks identifier 428, and a date range 430, among other options, controls, features, and components.

In addition to the above identified features, options, controls, and components, system 10 may also include a platform ad manager 450, an application server 460, an application programming interface 462, a plurality of databases 464, a plurality of datasets 466, data 470, a product identifier 472, product characteristics 474, a mobile application 476, a platform 478, an e-commerce platform 480, a plurality of products 482, a plurality of templates 484, an advertisement 486, and an advertisement campaign 488, among other options, controls, and components.

Variations Multivariate System:

In the arrangement shown, as one example, system 10 includes a variations multi-variate system. Variations multi-variate system is formed of any suitable size, shape, and design and is configured to provide multi-variate design options and testing options as well as provide for variations on multi-variate design options and testing options for the advertisement creations, publication rules and more.

In the arrangement shown, as one example, some of the mutli-variates for testing and parameters include, but are not limited to, pricing, datasets—including but not limited to patterns, fonts, colors, text variables, graphic variables—product types, sales channel, conversion rates and more. Additionally, in the arrangement shown as one example, system also conducts experiments and includes various parameters for the experiments such as timeframe, number of unit sales, number of variations to be tested per set, sales channel, conversion rates, and more.

Source Design Multivariate Experiments:

In the arrangement shown, as one example, multivariate system includes a source design multivariate experiment. Source design multivariate experiment is formed of any suitable size, shape, and design and is configured to split testing of source designs against one another, aggregate sales information from a source design variation, select multiple source designs to test against one another, select multiple advertisement designs for variation. Some of the variation includes, but is not limited to, pricing, product type, sales channel, product description, and more. Additionally, some of the parameters for these experiments includes, but is not, limited to, timeframe, number of unit sales, number of variations to be tested per set, sales channel, conversion rates, and more.

Brand Compliance Feature:

In the arrangement shown, as one example, system 10 includes a brand compliance feature. Brand compliance feature is formed of any suitable size, shape, and design and is configured to ensure advertisements and other generated items are compliant with branding rules and licensing requirements. In the arrangement shown, as one example, brand compliance feature includes a graphic compliance component, a text compliance component, an apparel colors component, and a multi-brand component, a design proportion feature, among other features and components.

In the arrangement shown, as one example, brand compliance features ensure that trademark symbols, trademark registration symbols, and the like match comply with branding guidelines. In the arrangement shown, as one example, text compliance features ensure that text of each brand, and the like match, comply with branding guidelines. In the arrangement shown, as one example, color compliance features ensure that colors of each brand, and the like match, comply with branding guidelines. In the arrangement shown, as one example, multi-brand compliance features ensure that a variation or inclusion of a plurality of brands complies with branding guidelines, in the arrangement shown, as one example, design proportion compliance features ensure that dimensions and proportions of each brand, and the like match, comply with branding guidelines.

Source Design and Staging:

in the arrangement shown, as one example, system 10 includes a source design and staging area and/or source design and staging area database. Source design and staging area is formed of any suitable size, shape, and design and is configured to provide a group of layered files to store data as well as unique identifiers for storing and retrieving various bits of data. This includes, but is not limited to, bits of data such as designer commission, tracking, sales, royalties, and more. Furthermore, this includes extracting layers of information from other relevant files, including extracting information from layers in an adobe illustrator file, for example.

Trademark Registration Checking:

in the arrangement shown, as one example, system 10 includes an automated trademark registration and automated trademark application query and search functionality. Trademark checker is formed of any suitable size, shape, and design and is configured to provide an automated check and/or checklist of trademarks that may be registered or pending before the united states patent and trademark office. In this way, the trademark checker can create blacklists and/or whitelists based on the trademark data retrieved as well as create rules for use and/or non-use of the trademark registrations and/or trademark applications and/or other relevant trademark information.

In Operation/Method of Use:

An advertisement creation and distribution system, process, and method of use for automatically designing, creating, and distributing multiple advertisements and/or advertisement campaigns for a plurality of products and/or platforms is presented herein. The system 10 presents multiple ways of accomplishing this task.

Design Template: One such way of launching a plurality of advertisements and/or advertisement campaigns for a product or a plurality of products, using system 10, is through ad templates or more specifically through design templates. In this way, a user can choose an advertisement template which is pre-designed and ready to display a product in a number of variations including text, layering, coloring, and arrangement variation, within a single template. A plurality of products can also be launched using the same template. Additionally, a user can create a new design template which can then be used to launch various advertisements and/or ad campaigns with a single product or a platform of products. In this way, the dataset page is used as a source for creating designs from uploaded layers. Each dataset is pre filled data in the database table, so the automated system can generate a design based on the dataset and/or datasets selected.

First, a user utilizes an existing design template or creates a design template of their own. A user must upload this data unless the data was not already uploaded automatically, or unless the data was not already uploaded by another user. Once the dataset is uploaded/created and appears on the dataset page, a user moves on to the design templates page.

Template design options: In the design template, a user will upload separate layers. A user will upload these layers unless the layers were already uploaded automatically, or unless the layers were not already uploaded by another user. A combination of the plurality of layers is what creates a final design. In the arrangement shown, as one example, the following layer options are available to a user: primary color layer, secondary color layer, logo 1 layer, logo 2 layer, shadow layer, wrinkle layer, black or white color layers, other design layers. However, other layers are hereby contemplated for use, including but not limited to, image layers, adjustment layers, fill layers, shape layers, type layers, filter layers, and more.

In the arrangement shown, as one example, a design may have a text layer which needs to colored with a primary color layer from the dataset. In this instance, a user uploads the primary color layer by selecting “primary color”. This indicates to the design system to retrieve the primary color data from the appropriate dataset. A user follows this same logic with each option. A user can add as many layers as a user would like. A user then selects the appropriate layer to be retrieved from the dataset. In the arrangement shown, as one example, a preview of the layer selected is displayed. In the arrangement shown, as one example, an “other layer” will appear with each design as is, meaning this “other layer” won't be colored, replaced with a text and/or logo, etc. In addition to adding layers and/or subtracting layers, as well as selecting the appropriate dataset to be retrieved for a layer, a user can “drag and drop” layers. In this way a user can put the layers in the desired sequence. Said another way, a user may change the sequence of which the layers will appear. In the arrangement shown, as one example, a user may change the sequence which the layers appear from the bottom to the top in a design.

Once a user has added and/or subtracted the desired number of layers, selected a dataset to be retrieved for each layer, and arranged the layers in a desired order, the final design may be created. In the arrangement shown, as one example, a final design preview is available. Once the user has evaluated the final design preview. The user indicates, by selecting a ready indicator, when all the layers are uploaded and ready. A final review of the data and the preview of the design is presented to a user before the user continues.

As a final step, as is shown in one example, a user clicks a create new design template indicator to start the automated design system. Once “Save” is clicked by a user, the system will start creating designs based, on the data the user has requested. Depending on the number of datasets and layers, the process could take some time to generate the many designs. In some instances, the process of design generation can be almost instant. In the arrangement shown, as one example, when the designs have been generated, a user can export the designs.

Creative Template: Another way of launching a plurality of advertisements and/or advertisement campaigns for a product or a plurality of products, using system 10, is through ad templates or more specifically through creative templates. In this way, a user can choose a creative template which is pre-designed and ready to display a product in a number of variations including text, layering, coloring, and arrangement variation, within a single template. A plurality of products can also be launched using the same template. Additionally, a user can create a new creative template which can then be used to launch various advertisements and/or ad campaigns with a single product or a platform of products. In this way, the dataset page is used as a source for creating designs from uploaded layers. Each dataset is pre filled data in the database table, so the automated system can generate a design based on the dataset and/or datasets selected. A creative template may need less information, for example, a creative template may require only a name and a license/brand, or a name and an ad text, for example.

Campaign Template: One such way of launching a plurality of advertisements and/or advertisement campaigns for a product or a plurality of products, using system 10, is through campaign templates. In this way, a user can choose a campaign template which is pre-designed and ready to display a product in a number of variations including text, layering, coloring, and arrangement variation, within a single template. A plurality of products can also be launched using the same template. Additionally, a user can create a new campaign template which can then be used to launch various advertisements and/or ad campaigns with a single product or a platform of products. In this way, the dataset page is used as a source for creating campaigns from uploaded layers. Each dataset is pre filled data in the database table, so the automated system can generate a design based on the dataset and/or datasets selected. A campaign template needs minimal information to launch an entire ad campaign based on a platform of products. For example, a campaign template may only need the license and a budget, or a license/brand and a placement (mobile/desktop/or other).

Audience Rule: One such way of launching a plurality of advertisements and/or advertisement campaigns for a product or a plurality of products, using system 10, is through audience rules. In this way, a user can choose a rule which is pre-designed and ready to display a product in a number of variations including text, layering, coloring, and arrangement variation, within a single template. A plurality of products can also be launched using the same audience rule. Additionally, a user can create an audience rule which can then be used to launch various advertisements and/or ad campaigns with a single product or a platform of products. In this way, the dataset page is used as a source for creating audience rules from uploaded data. Each dataset is pre filled data in the database table, so the automated system can generate a campaign based on the dataset and/or datasets selected. An audience rule needs minimal information to launch a campaign. For example, an audience rule may only need a location, or a reach goal, or a license and/or brand, or geographical area, or exclusion, or a language, and more. Audience rules are a flexible way to create a campaign.

Rules: One such way of launching a plurality of advertisements and/or advertisement campaigns for a product or a plurality of products, using system 10, is through rules. In this way, a user can choose an advertisement template which is pre-designed and ready to display a product in a number of variations including text, layering, coloring, and arrangement variation, within a single template. A plurality of products can also be launched using the same rule. Additionally, a user can create a new rule which can then be used to launch various advertisements and/or ad campaigns with a single product or a platform of products. In this way, the dataset page is used as a source for creating rules from uploaded layers. Each dataset is pre filled data in the database table, so the automated system can generate a design based on the dataset and/or datasets selected. As an example, a rule is and can be different from an audience rule. Where audience rules identify target audiences, rules identify one, or a number of other rules. These rules are not necessarily audience rules, such as license rules, level rules (campaign, ad set, single ad), or running, a campaign on a certain schedule or for a certain time period, or at certain intervals. A rule may be a single rule or a combination of many rules.

Furthermore, any single advertisement and/or advertisement campaign may be created and launched with only one of the above methods, any combinations of them, or even all of them. The pending page can be used to identify various ad and/or advertisement campaigns a user is working on. The automation page can be used as a hub where a user can automate and monitor various ads and/or advertisement campaigns and check the status of each and more. The reporting page provides various items about enabled or disabled campaign, ad sets, and ads which may have already been launched or are awaiting launch. Some of this data includes money spent on a campaign or ad as well as the reach of the ad and more. Furthermore, the system can retrieve products from a platform and create ads and/or advertisement campaigns based on the products listed on an e-commerce website with little to no user interaction. In some cases, a user may enter their credentials, including product website and simply launch a campaign with pre-filled or already created templates, rules, and more.

It will be appreciated by those skilled in the art that other various modifications could be made to the device without parting from the spirit and scope of this disclosure. All such modifications and changes fall within the scope of the claims and are intended to be covered thereby.

What is claimed:

1. An advertisement creation, distribution, and publishing system, comprising:
an application server;
an advertisement database;
a database;
the database having a plurality of datasets;
the datasets having data;
a product database;
a graphical user interface;
the graphical user interface having a advertisement design page feature;
the graphical user interface having a dataset page feature;
the graphical user interface having an export page feature;
wherein a user can generate a plurality of advertisements from a single advertisement design template.

2. The system of claim 1, further comprising:
wherein the user can distribute a plurality of advertisements from a single distribution template.

3. The system of claim 1, further comprising:
wherein the user can publish a plurality of advertisements from a single advertisement template.

4. The system of claim 1, further comprising:
a plurality of layers;
wherein the plurality of layers form an advertisement;
wherein the plurality of layers can be interchangeable such that a plurality of advertisement designs can be generated using the single advertisement design template.

5. The system of claim 1, further comprising:
a second advertisement design template;
a generate feature;
wherein the generate feature generates a plurality of advertisements from the second advertisement design template.

6. The system of claim 1, further comprising:
a content management system;
the content management system having a database associated with a plurality of licensing rules;
wherein the plurality of licensing rules are applied to the plurality of advertisements.

7. The system of claim 1, further comprising:
an advertising platform;
the advertising platform having an advertising feature;
the advertising platform having an upload advertising design feature;
an advertisement design distribution feature;
the advertisement design distribution feature having a dataset of advertisements:
wherein the advertisement design distribution feature uploads the dataset of advertisements and launches an advertisement campaign with a predetermined set of rules.

8. The system of claim 1, further comprising:
a variation feature;
the variation feature having an advertisement design manipulation rule set;
a content management system;
the content management system having a predetermined set of licensing rules;
an advertisement design;
the advertisement design having multiple layers;
wherein the advertisement design manipulation rule set of the variation feature automatically changes multiple layers of a design in accordance with the predetermined set of licensing rules.

9. The system of claim 1, further comprising:
an advertisement generator;
an advertisement design;
wherein the advertisement design is created by the user through the graphical user interface;
the advertisement design generated by the advertisement design template;
a predetermined set of advertisement design rules;
a performance ranking system;
the performance ranking system having a plurality of parameters;
the performance ranking system having a predetermined set of rules for ranking a plurality of parameters;
wherein the design generator produces a plurality of dynamically modified designs based on the set of rules for ranking a plurality of parameters of the performance ranking system;
wherein the plurality of parameters includes a click success rate.

10. The system of claim 1, further comprising:
a plurality of brands;
the plurality of brands each having a set of licensing rules;
a an advertisement design generator;
the advertisement design generator having a predetermined set of rules for each of the plurality of brands;
wherein the licensing rules are incorporated into the advertisement design generator so that advertisements can be generated which comply with the set of rules for each of the plurality of brands.

11. An advertisement creation, distribution, and publishing system, comprising:
an application server;
a product database;
a database;
the database having a plurality of datasets;
the datasets having data;
a graphical user interface;
the graphical user interface having an advertisement design page feature;
the graphical user interface having a dataset page feature;
the graphical user interface having an export page feature;
wherein a user can generate a plurality of advertisements from a single advertisement design template;
an advertisement campaign integration feature;
the advertisement campaign integration feature having a set of parameters associated with a plurality of advertisement hosts.

12. The system of claim 11, further comprising:
wherein the advertisement campaign integration feature integrates the advertisement design creation system with each of a plurality of advertisement hosts using the set of parameters associated with the respective advertisement host.

13. The system of claim 11, further comprising:
wherein the advertisement campaign integration feature integrates the distribution system with each of a plurality of advertisement hosts using, the set of parameters associated with the respective advertisement hosts.

14. The system of claim 11, further comprising:
wherein the advertisement campaign integration feature integrates the publishing system with each of a plurality of advertisement hosts using the set of parameters associated with the respective advertisement hosts;
a variation multivariate feature;
the variation multivariate feature having a plurality of variables;
a brand compliance feature;
an automated trademark checker feature.

15. The system of claim 11, further comprising:
a hulk upload feature;
the bulk upload feature having a plurality of advertisements;
a plurality of advertisement platforms;
the plurality of advertisement platforms having a selectable group;
wherein the plurality of advertisements are uploaded to the selectable group of the plurality of advertisement platforms.

16. The system of claim 11, further comprising:
a bulk upload feature;
the bulk upload feature having a plurality of advertisements;
a plurality of advertisement platforms;
the plurality of advertisement platforms having a selectable group;
wherein the plurality of designs are uploaded to the selectable group of the plurality of advertisement platforms;
wherein the plurality of advertisements are periodically launched by a set of predetermined rules learned by the bulk upload feature.

17. The system of claim 11, further comprising:
a bulk upload feature;
the bulk upload feature having a plurality of products;
a plurality of e-commerce platforms;
the plurality of e-commerce platforms having a selectable group;
wherein the plurality of advertisements are uploaded by the bulk upload feature to the selectable group of the plurality of e-commerce platforms, based on a predetermined set of rules and and at time intervals.

18. A method of designing, creating, and publishing advertisements, the method comprising the steps:
providing an application server;
providing a product database, the product database having a dataset having data;
providing a graphical user interface;
interacting with the graphical user interface;
providing a set of licensing rules associated with a brand;
providing, a set of layers;
integrating the set of licensing rules associated with a brand with the set of layers;
generating a plurality, of advertisement designs based on a single advertisement design through integration of the set of licensing rules and the set of layers.

19. The method of claim 18, further comprising the steps:
providing a bulk upload feature, the bulk upload feature having a plurality of advertisements;
integrating the bulk upload feature with a plurality of advertising platforms having a selectable group;
selecting a set of e-commerce platforms from the selectable group of the plurality of advertising platforms;
uploading a bulk set of advertisements to the plurality of advertising platforms with a single click.

20. The method of claim 18 further comprising the steps:
generating a plurality of advertisements based on products generated from the plurality of designs created;
providing a bulk upload feature;
integrating a plurality of advertising platforms with the bulk upload feature;
uploading the plurality of advertisements across a selected set of advertising platforms.
